(19) United States
(12) Patent Application Publication
(10) Pub. No.: US 2026/0295425 A1
(43) Pub. Date: Oct. 1, 2026

(54) COMMUNICATION SYSTEM, ONE OR MORE COMPUTER-READABLE STORAGE MEDIA, AND COMPUTER-IMPLEMENTED METHOD

(71) Applicant: Nintendo Co., Ltd., Kyoto (JP)

(72) Inventors: Yasutaka TAKEUCHI, Kyoto (JP); Yoshito UEYAMA, Kyoto (JP)

(21) Appl. No.: 19/560,934

(22) Filed: Mar. 9, 2026

(30) Foreign Application Priority Data
Mar. 27, 2025 (JP) 2025-054093

(51) Int. Cl. A63F 13/63; A63F 13/35; A63F 13/52; A63F 13/69

(52) U.S. Cl. CPC A63F 13/63; A63F 13/35; A63F 13/52; A63F 13/69

(57) ABSTRACT

A first communication terminal receives second information from a server, stores the received second information, acquires, based on a first image associated with the second information, the second information related to the first image from the server, and transmits, to the server, an instruction to transmit the first information associated with the second information acquired from the server to a first game apparatus. The server transmits, to the first game apparatus, the first information stored in the server and associated with the second information transmitted from the first communication terminal. The first game apparatus receives the first information transmitted from the server.

### CROSS REFERENCE TO RELATED APPLICATION

This application claims priority to Japanese Patent Application No. 2025-054093, filed on Mar. 27, 2025, the entire contents of which are incorporated herein by reference.

### FIELD

The technology disclosed herein relates to communication systems capable of being connected to a server, one or more computer-readable storage media, and computer-implemented methods.

### BACKGROUND AND SUMMARY

The present non-limiting example discloses a communication system, one or more computer-readable storage media, and a computer-implemented method in which a product object generated by a user in a game can be easily shared with another user.

The present non-limiting example has the following features (1)–(8), for example.

(1) A non-limiting example of a configuration of a communication system according to the present non-limiting example is a communication system comprising a first game apparatus and a first communication terminal, wherein the first game apparatus and the first communication terminal are configured to connect to a server, the first game apparatus is configured to execute a first game application, and during execution of the first game application, cause a product object generated based on a plurality of material objects to appear in a virtual space according to an instruction based on an operation input, store first information associated with the product object, cause the product object related to the first information to appear in the virtual space according to an instruction based on an operation input, and transmit the first information to the server according to an instruction based on an operation input, the server is configured to receive the first information from the first game apparatus or another game apparatus, generate second information related to the received first information and for identifying the product object, store the first information and the second information associated with the first information, and transmit the second information to the first communication terminal based on a request from the first communication terminal, the first communication terminal is configured to receive the second information from the server, store the received second information, acquire, based on a first image associated with the second information, the second information related to the first image from the server, and transmit, to the server, an instruction to transmit the first information associated with the second information acquired from the server to the first game apparatus, the server is configured to transmit, to the first game apparatus, the first information stored in the server and associated with the second information transmitted from the first communication terminal, and the first game apparatus is configured to receive the first information transmitted from the server.

With the configuration of (1), when the first image associated with the second information is acquired in the first communication terminal, the first information used for generating a product object in the first game apparatus can be acquired. In addition, since the acquisition of the first image allows acquisition of the second information that allows acquisition of the first information, the first information can be easily shared with another user using the first image.

(2) In the configuration of (1), the communication system may further comprise a second game apparatus and a second communication terminal, wherein the second game apparatus and the second communication terminal are configured to connect to the server. The second communication terminal may be configured to acquire, based on the first image, the second information related to the first image from the server, and transmit, to the server, an instruction to transmit the first information associated with the second information acquired from the server to the second game apparatus. The second game apparatus may be configured to acquire, from the server, the first information associated with the second information and designated by the second communication terminal, execute a second game application, and during execution of the second game application, cause a product object generated based on a plurality of material objects to appear in a virtual space according to an instruction based on an operation input, and cause a product object related to the first information acquired from the server to appear in the virtual space according to an instruction based on an operation input.

With the configuration of (2), the first information can be acquired using the first image, and therefore, can be easily shared with another user.

(3) In the configuration of (1) or (2), the first game apparatus may be configured to store at most a first number of pieces of the first information, newly store the first information associated with the product object in response to generation of the product object based on a plurality of the material objects according to an instruction based on an operation input, and when the first number is exceeded due to the newly stored first information, automatically delete one of the stored pieces of first information that started to be stored at a relatively early time.

With the configuration of (3), the first information is automatically deleted, and therefore, the storage capacity of the first game apparatus can be prevented from being accidentally limited. In addition, the user of the first game apparatus may desire to regenerate or duplicate a product object that is newly generated by the user, and therefore, by automatically deleting relatively old first information, a system having excellent usability can be implemented.

(4) In the configuration of (3), the first communication terminal may be configured to store at most a second number of pieces of the second information, newly store the second information in response to reception of the second information from the server, and when the second number is exceeded due to the newly stored second information, automatically delete one of the stored pieces of second information that started to be stored at a relatively early time.

With the configuration of (4), the second information is automatically deleted, and therefore, the storage capacity of the first communication terminal can be prevented from being accidentally limited. In addition, the user of the first communication terminal may desire to regenerate or duplicate a newly generated product object, and therefore, by automatically deleting relatively old second information, a system having excellent usability can be implemented.

(5) In the configuration of (4), the second number may be more than the first number.

With the configuration of (5), it is possible to reduce an increase in time it takes to select a piece of first information due to an increase in the number of pieces of first information stored in the first game apparatus. In addition, since the number of pieces of second information that can be stored in the first communication terminal is relatively increased, the desire of the user that desires to possess as many pieces of first information as possible can be satisfied, and therefore, the use of a system using the first communication terminal can be promoted.

(6) In the configuration of any one of (3)–(5), the first game apparatus may be configured to designate one of the stored pieces of first information according to an instruction based on an operation input, and when the first number is exceeded due to the newly stored first information, automatically delete one of the stored pieces of first information without deleting the designated first information.

With the configuration of (6), in the first game apparatus, the first information that is not to be automatically deleted is designated. Therefore, while the first information that the user does not desire to delete continues to be stored, the first information that the user does not refuse to delete is automatically deleted, resulting in a system having excellent usability.

(7) In the configuration of (4) or (5), the first communication terminal may be configured to designate one of the stored pieces of second information according to an instruction based on an operation input, and when the second number is exceeded due to the newly stored second information, automatically delete one of the stored pieces of second information without deleting the designated second information.

With the configuration of (7), in the first communication terminal, the second information that is not to be automatically deleted is designated. Therefore, while the second information that the user does not desire to delete continues to be stored, the second information that the user does not refuse to delete is automatically deleted, resulting in a system having excellent usability.

(8) In the configuration of any one of (1)–(7), the server may be configured to transmit, to the first communication terminal, a second image related to the second information and the first information and showing the product object. The first communication terminal may have a display section and may be configured to display the second image received from the server on the display section in association with the first image.

With the configuration of (8), the second image showing a simplified version of a product object that is caused to appear using the first information is displayed. Therefore, the second information acquired by the first communication terminal or the second information to be transmitted to the server can be easily designated.

In addition, the present non-limiting example may be carried out in the forms of one or more computer-readable storage media and a computer-implemented method. A non-limiting example of one or more computer-readable storage media described herein may store instructions that, when executed, cause one or more processors included in an information process apparatus to execute the above operations.

According to the present non-limiting example, when an image associated with second information is acquired in a communication terminal, first information used for generating a product object in a game apparatus can be acquired.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram showing a non-limiting example of a communication system 100 according to the present non-limiting example,

FIG. 2 is a diagram showing a non-limiting example of a state where a left controller 3 and a right controller 4 are attached to a main body apparatus 2,

FIG. 3 is a diagram showing a non-limiting example of a state where both of the left controller 3 and the right controller 4 are detached from the main body apparatus 2,

FIG. 4 is six orthogonal views showing a non-limiting example of the main body apparatus 2,

FIG. 5 is six orthogonal views showing a non-limiting example of the left controller 3,

FIG. 6 is six orthogonal views showing a non-limiting example of the right controller 4,

FIG. 7 is a block diagram showing a non-limiting example of an internal configuration of the main body apparatus 2,

FIG. 8 is a block diagram showing a non-limiting example of internal configurations of the main body apparatus 2, the left controller 3, and the right controller 4,

FIG. 9 is a block diagram showing a non-limiting example of a configuration of a communication terminal 150,

FIG. 10 is a block diagram showing a non-limiting example of a configuration of a server 200,

FIG. 11 is a diagram showing a non-limiting example of a game image displayed on a display 12,

FIG. 12 is a diagram showing a non-limiting example of an assembled object produced by putting a rock object OBJg and a box object OBJf together,

FIG. 13 is a diagram showing a non-limiting example of an assembled object produced by putting an engine object OBJa and a wing object OBJb together,

FIG. 14 is a diagram showing a non-limiting example of a game image displayed when an assembled object that is caused to appear in a virtual space is recorded,

FIG. 15 is a diagram showing a non-limiting example of a game image in a game mode in which an assembled object is caused to appear in a virtual space,

FIG. 16 is a diagram showing a non-limiting example of a game image in which an assembled object based on a recorded blueprint has been caused to appear in a virtual space;

FIG. 17 is a sequential diagram showing a non-limiting example of a communication process operation between a game system 1, a communication terminal 150, and a server 200,

FIG. 18 is a diagram showing a non-limiting example of an application-possessed blueprint list displayed on a display section 155 of a communication terminal 150,

FIG. 19 is a diagram showing a non-limiting example of a blueprint list displayed on a display 12 of a game system 1,

FIG. 20 is a diagram showing a non-limiting example of an image displayed on each of a display 12 of a game system 1 and a display section 155 of a communication terminal 150 when a blueprint is downloaded from the game system 1,

FIG. 21 is a diagram showing a non-limiting example of an image displayed on each of a display 12 of a game system 1 and a display section 155 of a communication terminal 150 when URL information Cy is read in the communication terminal 150,

FIG. 22 is a diagram showing a non-limiting example of an image displayed on each of a display 12 of a game system 1 and a display section 155 of a communication terminal 150 when a blueprint is transmitted from the communication terminal 150 to the game system 1,

FIG. 23 is a diagram showing a non-limiting example of a data area set in a DRAM 85 of a main body apparatus 2 in a first non-limiting example,

FIG. 24 is a flowchart showing a non-limiting example of an information process and a communication process that are executed in a game system 1,

FIG. 25 is a subroutine showing a specific non-limiting example of a recording process executed in step S126 shown in FIG. 24,

FIG. 26 is a subroutine showing a specific non-limiting example of an appearance process executed in step S128 shown in FIG. 14,

FIG. 27 is a subroutine showing a specific non-limiting example of a blueprint transmission/reception process that is executed in step S129 shown in FIG. 24,

FIG. 28 is a diagram showing a non-limiting example of a data area set in a storage section 152 of a communication terminal 150,

FIG. 29 is a flowchart showing a non-limiting example of an information process and a communication process that are executed in a communication terminal 150,

FIG. 30 is a diagram showing a non-limiting example of a data area set in a storage section 203 of a server 200, and

FIG. 31 is a flowchart showing a non-limiting example of an information process and a communication process that are executed in a server 200.

### DETAILED DESCRIPTION OF NON-LIMITING EXAMPLE EMBODIMENTS

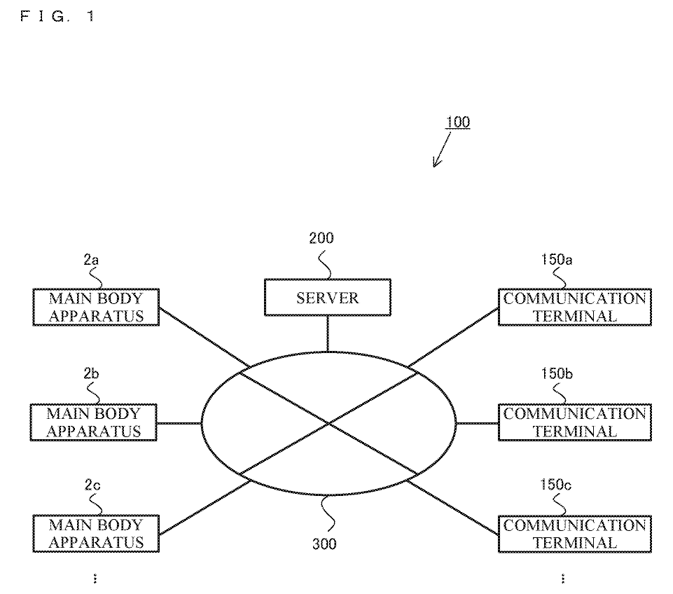

A communication system according to the present non-limiting example will be described with reference to FIG. 1. As shown in FIG. 1, a communication system 100 that is a non-limiting example of the communication system is constructed by a main body apparatus 2, a communication terminal 150, and a server 200 being connected together via a network 300. Although in FIG. 1, a plurality of the main body apparatuses 2 and a plurality of the communication terminals 150 are shown, the communication system 100 may include only one main body apparatus 2 and only one communication terminal 150.

The main body apparatus 2 and the communication terminal 150 are configured to connect to the network 300 through wireless or wired communication, and together with the server 200 form a client-server system. For example, the main body apparatus 2 and the communication terminal 150 can each execute a predetermined application. In addition, the main body apparatus 2 and the communication terminal 150 can execute the predetermined applications to establish connection to the server 200 via the network 300 and thereby communicate with the server 200. In addition, each pair of a main body apparatus 2 and a communication terminal 150 (e.g., a pair of a main body apparatus 2a and a communication terminal 150a, a pair of a main body apparatus 2b and a communication terminal 150b, and a pair of a main body apparatus 2c and a communication terminal 150c shown in FIG. 1) are associated with each other by respective predetermined information (e.g., the same account).

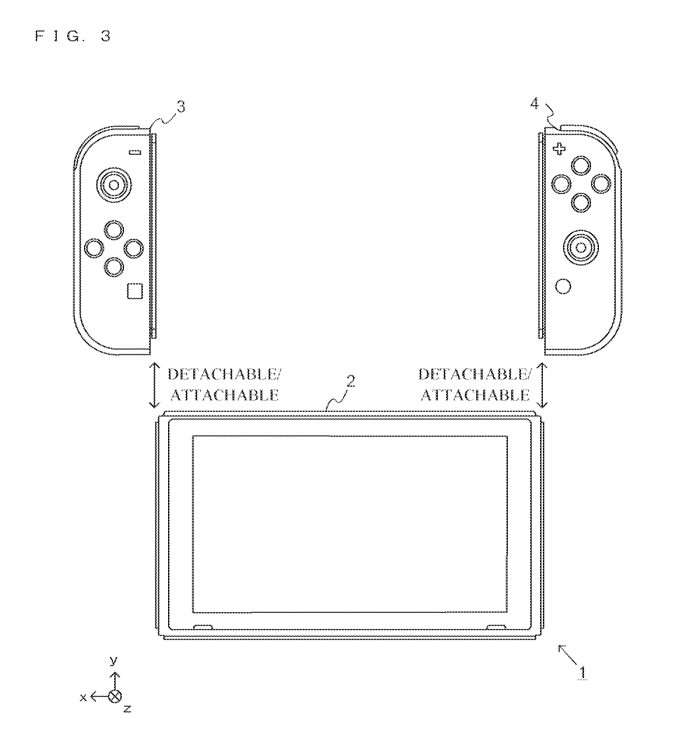

A game system according to the present non-limiting example will now be described. A non-limiting example of a game system 1 according to the present non-limiting example includes a main body apparatus (information processing apparatus serving as the main body of a game apparatus in the present non-limiting example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 3). In the description that follows, a hardware configuration of the game system 1 of the present non-limiting example is described, and thereafter, the control of the game system 1 of the present non-limiting example is described.

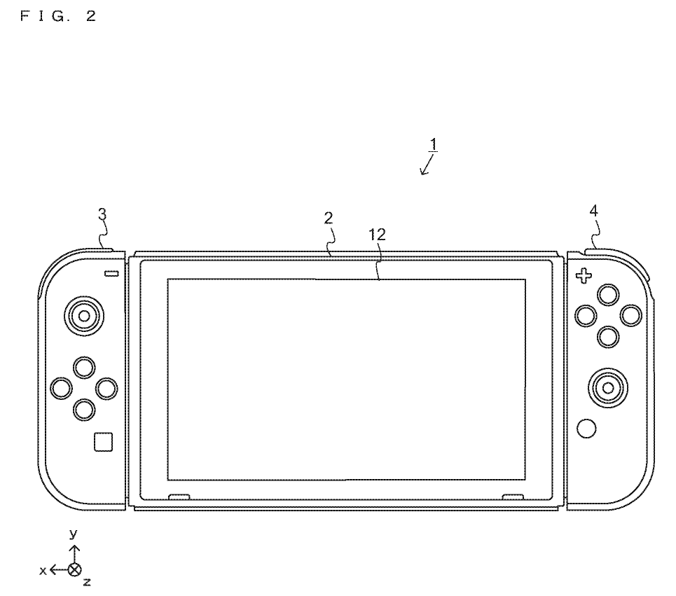

FIG. 2 is a diagram showing a non-limiting example of the state where the left controller 3 and the right controller 4 are attached to the main body apparatus 2. As shown in FIG. 2, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 3 is a diagram showing a non-limiting example of the state where each of the left controller 3 and the right controller 4 is detached from the main body apparatus 2. As shown in FIGS. 2 and 3, the left controller 3 and the right controller 4 are attachable to and detachable from the main body apparatus 2. It should be noted that hereinafter, the left controller 3 and the right controller 4 will occasionally be referred to collectively as a “controller”.

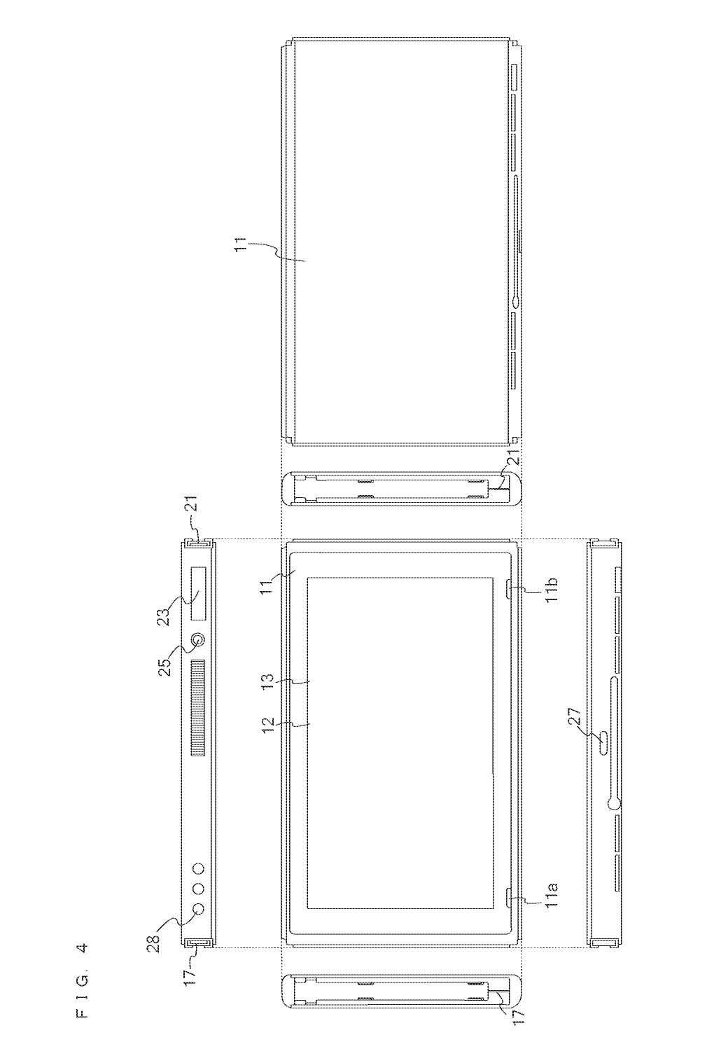

FIG. 4 is six orthogonal views showing a non-limiting example of the main body apparatus 2. As shown in FIG. 4, the main body apparatus 2 includes an approximately plate-shaped housing 11. In the present non-limiting example, a main surface (in other words, a surface on a front side that is a surface on which the display 12 is provided) of the housing 11 has a generally rectangular shape.

In addition, the main body apparatus 2 includes a touch panel 13 on the screen of the display 12. In the present non-limiting example, the touch panel 13 allows multi-touch input (e.g., a capacitive touch panel). It should be noted that the touch panel 13 may be of any suitable type, e.g., it allows single-touch input (e.g., a resistive touch panel).

As shown in FIG. 4, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present non-limiting example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present non-limiting example, the cradle has the function of charging the unified apparatus or the main body apparatus 2 alone, being placed thereon. The cradle also functions as a hub device (specifically, a USB hub).

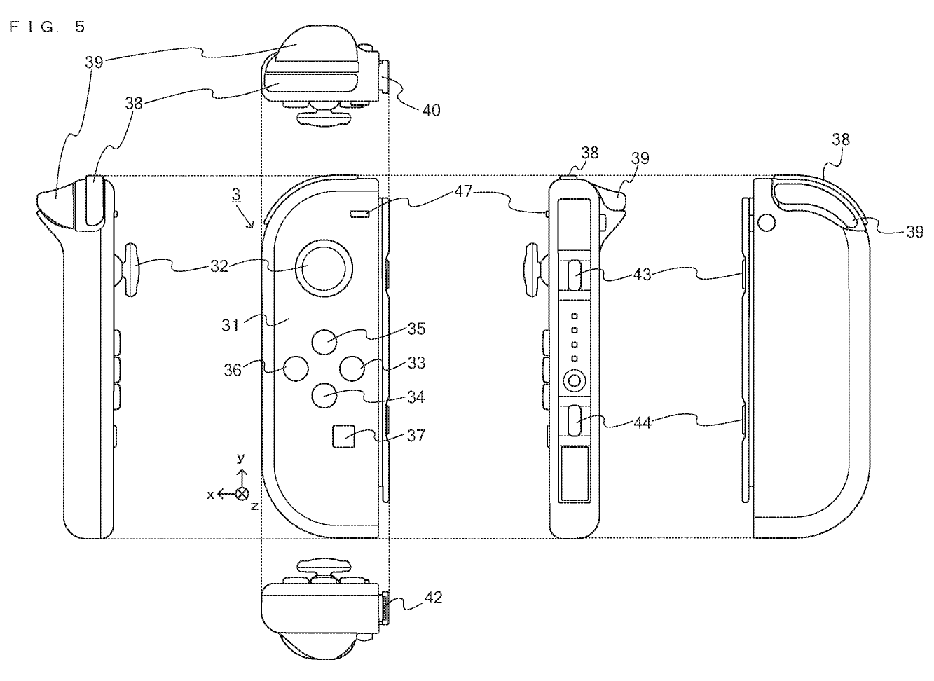

FIG. 5 is six orthogonal views showing a non-limiting example of the left controller 3.

The left controller 3 includes an analog stick 32. As shown in FIG. 5, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present non-limiting example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

The left controller 3 also includes a terminal 42 that enables wired communication between the left controller 3 and the main body apparatus 2.

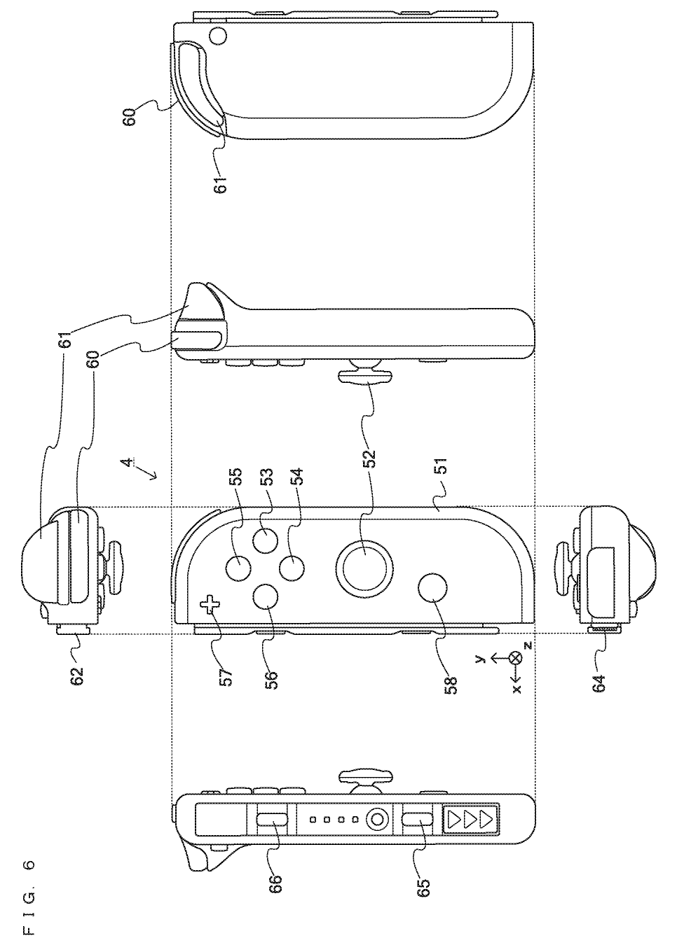

FIG. 6 is six orthogonal views showing a non-limiting example of the right controller 4. The left controller 3 and the right controller 4 basically share a common configuration, and therefore, the right controller 4 will not be described in detail.

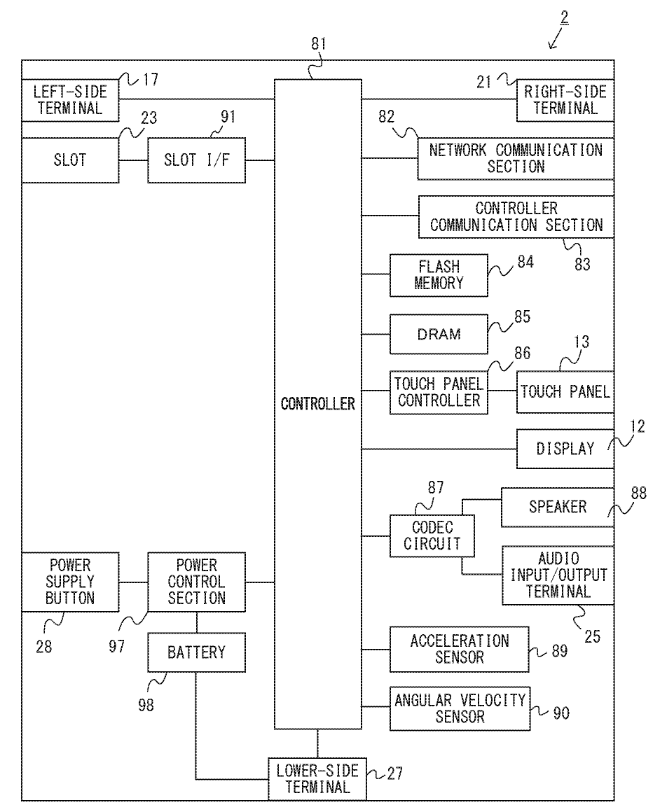

FIG. 7 is a block diagram showing a non-limiting example of an internal configuration of the main body apparatus 2. The main body apparatus 2 includes components 81 to 91, 97, and 98 shown in FIG. 7 in addition to the components shown in FIG. 4. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2, and may include various types of processing circuits. For example, the processor 81 may include only a central processing unit (CPU), or may be a system-on-a-chip (SoC) having a plurality of functions such as a CPU function and a graphics processing unit (GPU) function, or the like, and may include a non-imperative integrated circuit (IC) (fully hard-wired logic type application-specific integrated circuit (ASIC)). The processor 81 executes an information processing program (e.g., a game program or communication program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus (e.g., the server 200) via a network (e.g., the network 300). In the present non-limiting example, as a first communication form, the network communication section 82 connects to a wireless LAN and communicates with an external apparatus, using a method compliant with the Wi-Fi (registered trademark) standard. Further, as a second communication form, the network communication section 82 wirelessly communicates with another main body apparatus 2 of the same type, using a predetermined communication method (e.g., communication based on a unique protocol or infrared light communication).

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present non-limiting example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present non-limiting example, the main body apparatus 2 can perform both wired communication and wireless communication with each of the left and right controllers 3 and 4. Further, when the unified apparatus acquired by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Further, the display 12 is connected to the processor 81. The processor 81 displays, on the display 12, a generated image (e.g., an image generated by executing the above information processing) and/or an externally acquired image.

The main body apparatus 2 also includes an acceleration sensor 89 and an angular acceleration sensor 90.

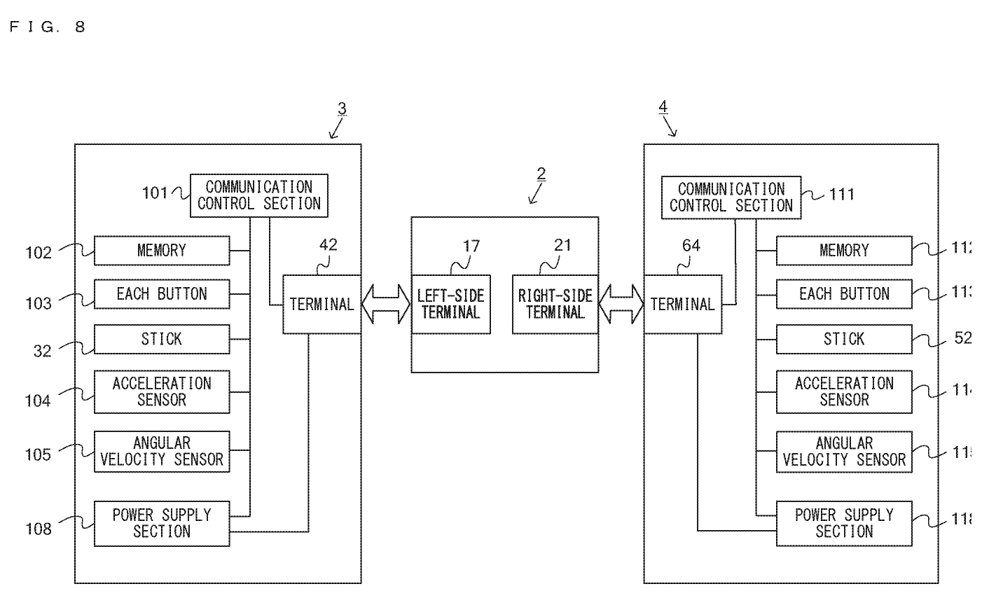

FIG. 8 is a block diagram showing non-limiting examples of the internal configurations of the main body apparatus 2, the left controller 3, and the right controller 4. It should be noted that the details of the internal configuration of the main body apparatus 2 are shown in FIG. 7 and therefore are omitted in FIG. 8. The left controller 3 and the right controller 4 basically share a common configuration, and in the description that follows, the left controller 3 is described.

The left controller 3 includes a communication control section 101, which communicates with the main body apparatus 2. As shown in FIG. 8, the communication control section 101 is connected to components including the terminal 42. In the present non-limiting example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 8) 32. Each of the buttons 103 and the analog stick 32 outputs information regarding an operation performed on itself to the communication control section 101 repeatedly at appropriate timing.

The left controller 3 includes inertial sensors. Specifically, the left controller 3 includes an acceleration sensor 104. Further, the left controller 3 includes an angular velocity sensor 105. In the present non-limiting example, the acceleration sensor 104 detects the magnitudes of accelerations along predetermined three axial (e.g., xyz axes shown in FIG. 5) directions. It should be noted that the acceleration sensor 104 may detect an acceleration along one axial direction or accelerations along two axial directions. In the present non-limiting example, an angular velocity sensor 105 detects angular velocities about predetermined three axes (e.g., the xyz axes shown in FIG. 5). It should be noted that the angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are output to the communication control section 101 repeatedly at appropriate timing.

The communication control section 101 acquires information regarding an input (specifically, information regarding an operation or the detection result of the sensor) from each of input sections (specifically, the buttons 103, the analog stick 32, and the sensors 104 and 105). The communication control section 101 transmits operation data including the acquired information (or information acquired by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data. Further, the main body apparatus 2 can calculate information regarding the motion and/or the orientation of the left controller 3 based on the operation data (specifically, the detection results of the acceleration sensor 104 and the angular velocity sensor 105).

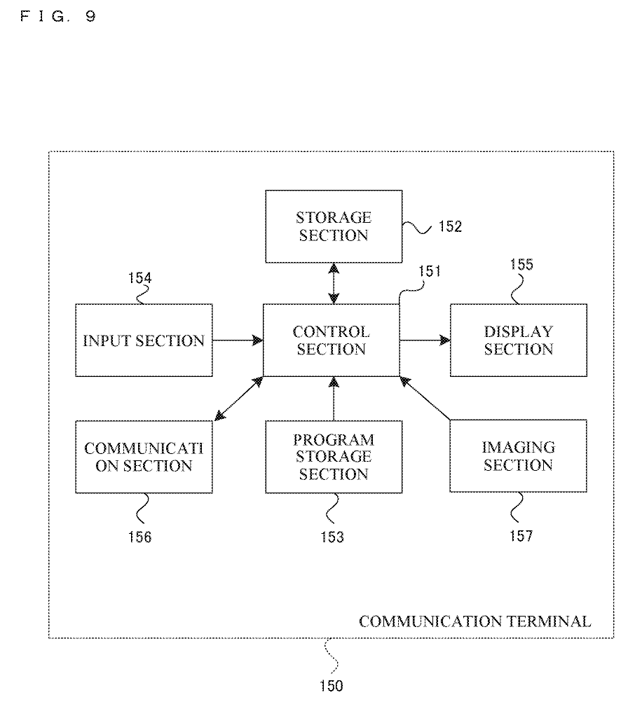

Next, the communication terminal 150 will be described with reference to FIG. 9. It should be noted that FIG. 9 is a block diagram showing a non-limiting example of the configuration of the communication terminal 150. For example, the communication terminal 150 can execute an information processing program that is stored in a replaceable storage medium such as a memory card or optical disc, or is received from another apparatus. The communication terminal 150 may be a smart device such as a smartphone or tablet, or alternatively, a typical personal computer, stationary game machine, mobile telephone, handheld game console, personal digital assistant (PDA), or the like.

In FIG. 9, the communication terminal 150 includes a control section 151, a storage section 152, a program storage section 153, an input section 154, a display section 155, a communication section 156, and the like. It should be noted that the communication terminal 150 may include one or more devices including an information processing device including at least the control section 151, and other devices.

The control section 151 is an information processing processor (computer) for executing various information processes, such as a CPU. For example, the control section 151 has functions of executing information processes described below, a data transmission/reception processes executed through the server 200, and the like. Each function of the control section 151 is carried out by the CPU executing a predetermined program.

The storage section 152 stores various items of data that are used when the control section 151 executes the above information processes. The storage section 152 is, for example, a memory that can be accessed by a CPU (e.g., the control section 151).

The program storage section 153 stores programs. The program storage section 153 may be any storage device (non-transitory storage medium) that can be accessed by the control section 151. For example, the program storage section 153 may be a storage device that is provided in the information processing device including the control section 151, or a non-transitory storage medium that is removably attached to the information processing device including the control section 151. The program storage section 153 may be a storage device (e.g., a server, etc.) that is connected to the control section 151 via a network. The control section 151 (CPU) may read all or a portion of a game program into the storage section 152 and execute the read program with appropriate timing.

The input section 154 is an input device that can be operated by a user. The input section 154 may be any suitable input device. As a non-limiting example, the input section 154 may be a touch panel provided on a screen of the display section 155. For example, the touch panel may be of any type. The touch panel may be either of a type that allows a multi-touch input (e.g., a capacitive type) or of a type that allows a single-touch input (e.g., a resistive type).

The display section 155 displays an image according to an instruction from the control section 151. It should be noted that when the communication terminal 150 is a stationary game apparatus or a personal computer, the display section 155 may be separated from the communication terminal 150.

The communication section 156, which is a predetermined communication module, exchanges data with another apparatus (e.g., the server 200) or another communication terminal 150 via the network 300.

The imaging section 157 includes a camera that captures an image of the real world around the communication terminal 150, and outputs the captured image data to the control section 151, and the like. It should be noted that in another non-limiting example, the communication terminal 150 may not be equipped with the imaging section 157, and may be configured to capture an image using a camera connected to the communication terminal 150.

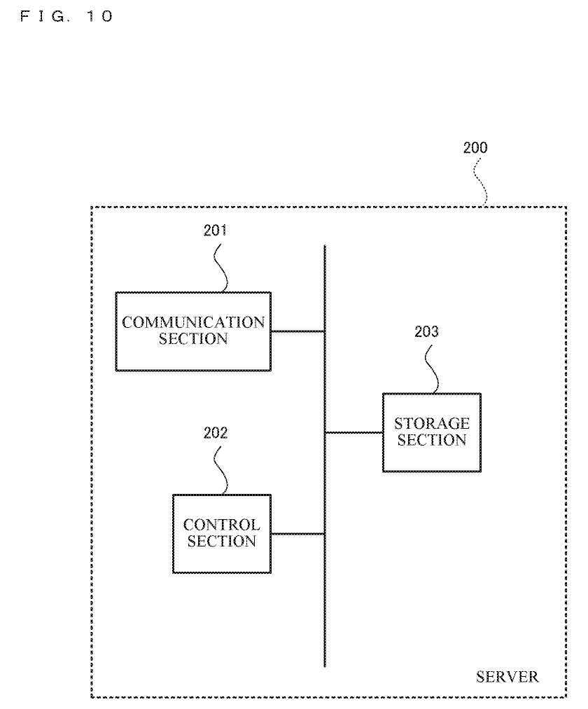

Next, the server 200 will be described with reference to FIG. 10. FIG. 10 is a block diagram showing a non-limiting example of the configuration of the server 200. The server 200 has a communication section 201, a control section 202, a storage section 203, and the like.

The communication section 201 communicates with the game system 1 (the main body apparatus 2), the communication terminal 150, and the like via the network 300 by exchanging communication packets. The control section 202 performs a process of managing the accounts of users of the server 200, and a process of managing a blueprint possessed by each user, and in addition, establishes a communication link to the game system 1 (the main body apparatus 2), the communication terminal 150, and the like, via the communication unit 201, and performs data transmission control and routing on the network 300. It should be noted that the control section 202 performs a process of managing the progression of a game performed along with the game system 1, a process of managing in-game currency, game items, game objects, and the like that are purchased by the user, a process of managing information about payment or charging, and the like. In addition, in the case in which the control section 202 performs a game together with a plurality of game systems 1, the control section 202 may manage a combination of game systems 1 performing the game, and data communication with the game systems 1 (the main body apparatuses 2). The storage unit 203 stores programs that are executed by the control section 202, data managed in the above processes, various items of data required for the above processes, various items of data required for communication with the game system 1 and the communication terminal 150, and the like. It should be noted that in the case in which the system employs a predetermined log-in process for data exchange performed via the network 300, the server 200 may perform an authentication process to determine whether or not a user that tries to log in using an account or the like is an authorized user. The server 200 may be a single server machine or may include a plurality of server machines.

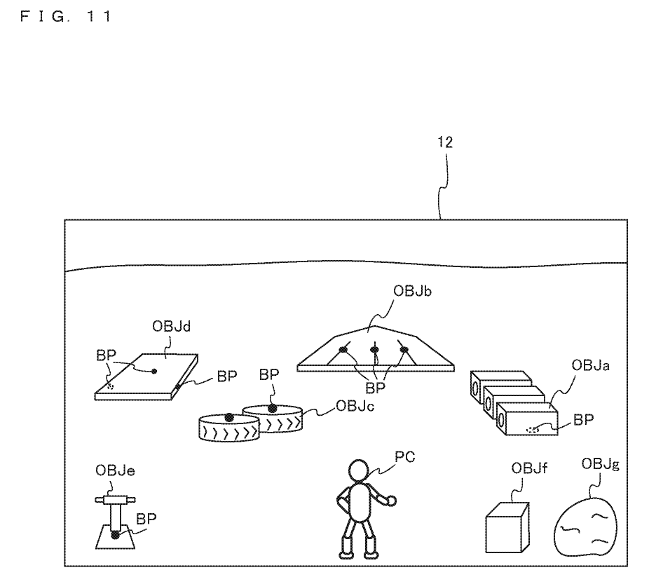

Next, before describing specific processes executed by the game system 1, the communication terminal 150, and the server 200, a game process executed in the game system 1 will be outlined with reference to FIGS. 11–16. In the description that follows, although a game is used as a non-limiting example of an application executed in the game system 1, other applications may be executed in the game system 1.

### First Non-Limiting Example

Next, a first non-limiting example of a game that is performed in the game system 1 will be described. During the start of the game that is performed in the game system 1, a virtual space is generated. For example, in the virtual space, a virtual camera and a player character PC are disposed. The virtual camera is set behind the player character PC. A game image including the player character PC is generated using the virtual camera, and is displayed on the display 12 or a stationary monitor.

FIG. 11 is a diagram showing a non-limiting example of a game image that is displayed on the display 12 when the game of the present non-limiting example is performed. As shown in FIG. 11, the game image includes the player character PC, and a plurality of material objects OBJ (OBJa–OBJg) as a virtual object disposed in the virtual space. The player character PC is operated by the user. The player character PC moves in the virtual space, and produces an assembled object (product) by putting a plurality of material objects OBJ together, according to the user’s operation performed on the main body apparatus 2, the left controller 3, and/or the right controller 4.

The plurality of material objects OBJ are an object that can be moved in the virtual space according to the user’s operation, and can be configured to be a part that is included in an assembled object. For example, the plurality of material objects OBJ are previously disposed on a ground in the virtual space. Alternatively, the plurality of material objects OBJ may be caused to appear in the virtual space according to the user’s operation. For example, when the player character PC knocks down an enemy character or solves a predetermined problem, a material object OBJ may appear in the virtual space.

The user can put a plurality of material objects OBJ together to produce an assembled object. For example, the user can produce, as an assembled object, a vehicle object, such as a car, tank, aircraft, or boat, a weapon object for attacking an enemy character, or the like, and can play a game using the produced assembled object. For example, the player character PC can sit on the produced vehicle object, and can move in the virtual space by driving the vehicle object, or can attack an enemy character using the weapon object. It should be noted that the user can arbitrarily set the positions and/or orientations of a plurality of material objects OBJ and put the material objects OBJ together. Therefore, by putting a plurality of material objects OBJ together, the user can produce an assembled object that has no function, or a virtual object that is merely an object or ornament.

In the non-limiting example of FIG. 11, as a non-limiting example of a plurality of material objects OBJ disposed in the virtual space, an engine object OBJa, a wing object OBJb, a wheel object OBJc, a board object OBJd, a control stick object OBJe, a box object OBJf, and a rock object OBJg are shown.

The engine object OBJa is a material object that functions as a power to move a vehicle object. The engine object OBJa, when incorporated as a part into an assembled object, applies an acceleration, velocity, angular velocity, angular acceleration, or the like to the whole assembled object. The wing object OBJb is a material object that has a function of allowing a vehicle object to move in the air in the virtual space.

The wheel object OBJc is a material object that functions as a power to move a vehicle object. For example, the wheel object OBJc can be configured as a vehicle wheel. The board object OBJd is a material object that is a building material in the shape of a flat plate. The board object OBJd can, for example, be used as the body of a vehicle object. For the board object OBJd, a wall can be formed in the virtual space by arranging a plurality of the board objects OBJd in an upright position, and a three-dimensional object can be produced by putting a plurality of the board objects OBJd together.

The control stick object OBJe is a material object that has a function of controlling a movement direction of a vehicle object, and applies a force in a direction in which a vehicle object turns.

The box object OBJf is a material object that is a building material having a three-dimensional shape such as a cube or rectangular parallelepiped. The box object OBJf can be configured as a building material (e.g., a portion of a car body) for various assembled objects. The rock object OBJg is a material object that is a mass-shaped (e.g., circular or angulated), board-shaped, or bar-shaped building material which imitates a rock.

It should be noted that other material objects may be further prepared as a part of an assembled object.

As shown in FIG. 11, for a material object OBJ, one or more bonding points BP may be set. A bonding point BP is a position where material objects OBJ are bonded (connected) with each other with higher priority. A bonding point(s) BP is previously set for each material object OBJ by a game creator. For example, a bonding point BP is set at the bottom surface of the engine object OBJa. Three bonding points BP are set at the upper surface of the wing object OBJb. One or more bonding points BP are set for the wheel object OBJc, the board object OBJd, and the control stick object OBJe. It should be noted that no bonding point BP is set for the box object OBJf or the rock object OBJg.

The user selects one from the material objects OBJ (stored objects) stored by the player character PC and the material objects OBJ disposed in the virtual space, and bonds the selected material object OBJ with another material object OBJ to put the plurality of material objects OBJ together. As a result, the user can produce an assembled object acquired by putting the plurality of material objects OBJ together, as a product.

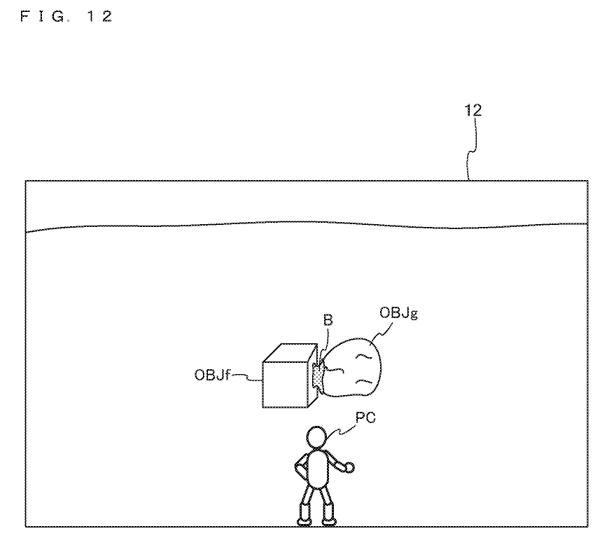

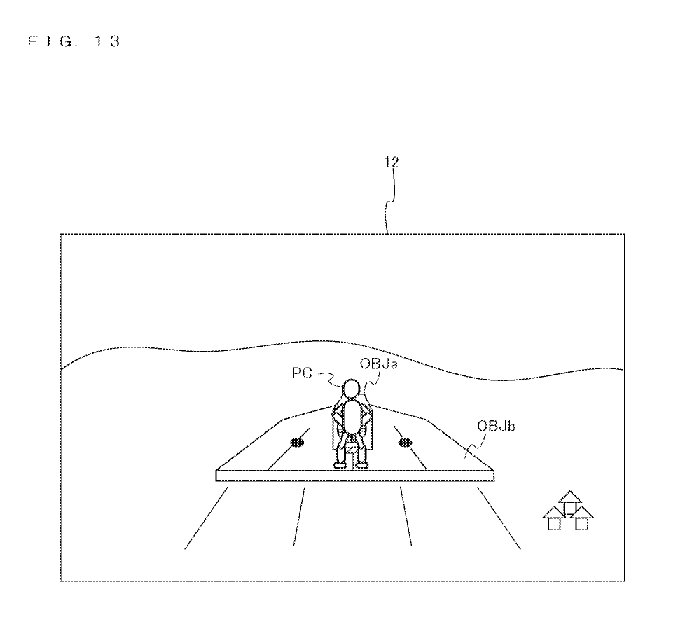

A non-limiting example in which material objects OBJ are put together to produce an assembled object will be described with reference to FIGS. 12 and 13. FIG. 12 is a diagram showing a non-limiting example of an assembled object produced by putting the rock object OBJg and the box object OBJf together. FIG. 13 is a diagram showing a non-limiting example of an assembled object produced by putting the engine object OBJa and the wing object OBJb together.

As shown in FIG. 12, an assembled object is produced by putting the rock object OBJg and the box object OBJf, which are disposed in the virtual space, together. Specifically, the player character PC moves and brings the rock object OBJg into contact with the box object OBJf according to the user’s operation. Thereafter, the player character PC performs a motion of bonding the rock object OBJg and the box object OBJf together at a predetermined position using a bonding object B according to the user’s operation, to produce an assembled object in which the rock object OBJg and the box object OBJf are put together.

As shown in FIG. 13, an assembled object (vehicle object) is produced by putting the engine object OBJa and the wing object OBJb together. Specifically, the player character PC moves and mounts the engine object OBJa at or near the center of the upper surface of the wing object OBJb according to the user’s operation. Thereafter, the player character PC performs a motion of bonding the engine object OBJa and the wing object OBJb together with bonding points BP thereof in contact with each other using a bonding object B according to the user’s operation, to produce an assembled object in which the engine object OBJa and the wing object OBJb are put together. FIG. 13 shows a situation in which the player character PC sits on a vehicle object acquired by putting the engine object OBJa and the wing object OBJb together, and drives the vehicle object to move in the air.

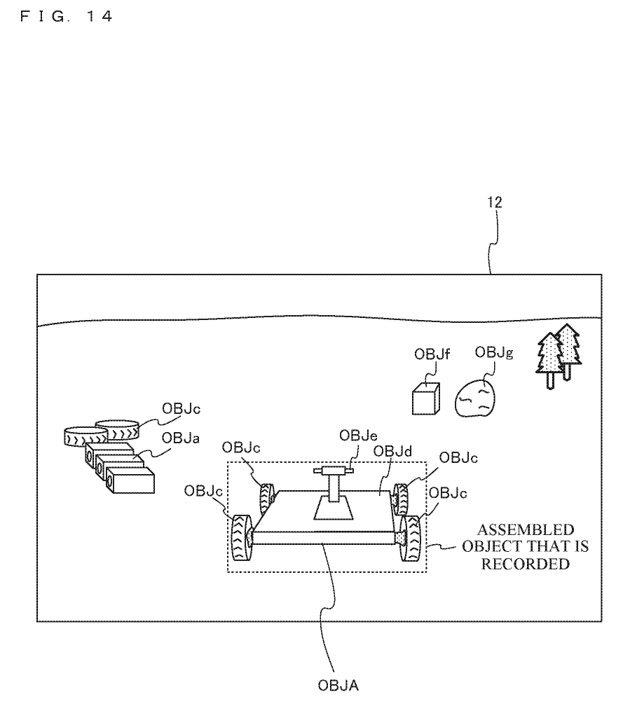

A process of recording an assembled object that is caused to appear in the virtual space will be described with reference to FIG. 14. It should be noted that FIG. 14 is a diagram showing a non-limiting example of a game image displayed when an assembled object that is caused to appear in the virtual space is recorded. Although in the description that follows, a game is used as a non-limiting example of an application executed in the game system 1, other applications may be executed in the game system 1.

In FIG. 14, the display 12 of the game system 1 displays a game image that is a subjective image of the virtual space as viewed from the player character PC. The subjective image is a game image that is used to record, as a blueprint, an assembled object produced by the player character PC, and that can be displayed in a record mode set according to the user’s operation.

In the non-limiting example of FIG. 14, the virtual space in which an assembled object OBJA and a plurality of material objects OBJa, OBJc, OBJf, and OBJg are disposed is displayed as the above subjective image. For example, the assembled object OBJA is produced by the player character PC in the virtual space as described above, by putting together stored objects temporarily stored by the player character PC and material objects disposed in the virtual space. Specifically, the assembled object OBJA is produced as a vehicle object including four wheel objects OBJc, one board object OBJd, and one control stick object OBJe.

In the game mode in which an assembled object is recorded (e.g., the record mode), in the case where an assembled object is displayed in a game image, design information of the assembled object displayed in the game image is recorded according to the user’s operation of recording the assembled object. As used herein, the design information refers to structure data of an assembled object for producing the assembled object again in the virtual space. For example, the design information contains the types of material objects constituting an assembled object, the positions where the material objects are bonded together, and the orientations of the material objects, and the like.

In the game mode in which an assembled object is recorded, when the user’s operation of recording an assembled object is performed, a game scene is exhibited in which a game image displayed at the time of the user’s operation is captured (e.g., a game scene in which a sound effect such as shutter sound is output, and a still game image at said time point is displayed). Thereafter, a game scene is exhibited which indicates that an assembled object included in the game image is recorded as a blueprint, and the user is thereby notified of the record assembled object. Here, the blueprint is created based on the captured image, and shows an external appearance of the assembled object based on the design information, for example. As a non-limiting example, in addition to the image showing the blueprint in which the assembled object is displayed, information indicating that the blueprint is recorded is presented to the user using text, sound, or the like, whereby the user is notified that the assembled object is recorded as a blueprint. It should be noted that even in the case where an assembled object is not fully shown in a game image in the image capture scene, the blueprint of the assembled object may be recorded. In the case where a plurality of assembled objects are included in a game image in the image capture scene, the assembled object that is closest to the viewpoint (the position of the virtual camera) from which the game image has been captured, the assembled object whose image occupies the largest surface area in the game image, or the assembled object that includes the greatest number of material objects, may be recorded.

Although in the foregoing, a game image displayed at the time of the user’s operation is captured as an image capture range, for example. Alternatively, instead of the entire displayed game image, a portion of the game image may be captured as an image capture range. As a non-limiting example, a rectangular range at or near the center of a displayed image of the virtual space, which is a portion of the displayed image, may be set as an image capture range. In that case, instead of the entire displayed image of the virtual space, an image of the virtual space displayed in the rectangular range is an image capture range, and the game image in the image capture range is handled as a game image in an image capture scene.

In the above example, when the user’s operation of recording an assembled object is performed, a game scene is exhibited in which a game image displayed at the time of the user’s operation is captured, and an assembled object to be recorded is selected from the captured game image. An assembled object to be recorded may be selected and recorded in other ways. For example, a cursor for selecting an assembled object to be recorded as a blueprint may be displayed and superimposed on a game image, and an assembled object on which the cursor is displayed and superimposed at the time of the user’s operation of recording an assembled object may be recorded as a blueprint. In that case, the above game scene for capturing a game image may not be exhibited, and a game image at the time of the user’s operation may be handled as the above captured game image, whereby the process of recording an assembled object selected by the user as a blueprint can be executed as in the above recording process. Specifically, a game image that is a subjective image from the player character PC and in which an assembled object to be recorded that has been selected using the cursor is disposed such that the barycenter of the viewed surface of the assembled object is located at the center of the angle of view, may be created and recorded as a blueprint. In the embodiment in which an assembled object is selected and recorded using a cursor, the recording process may be performed by other recording procedures or schemes.

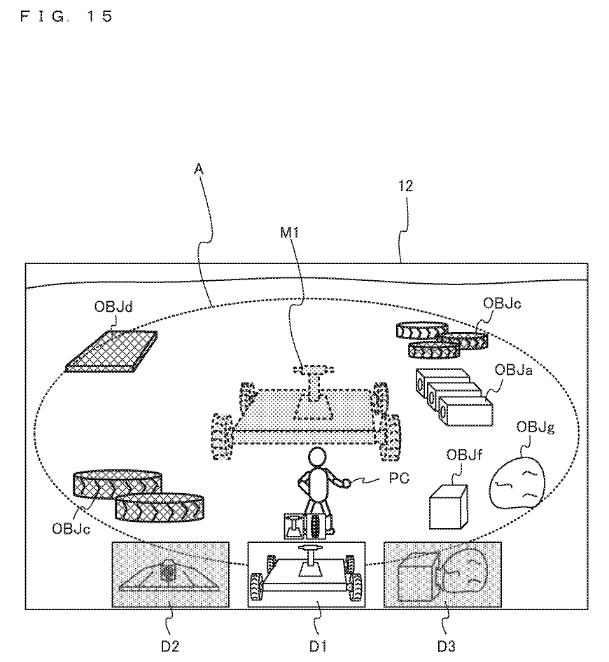

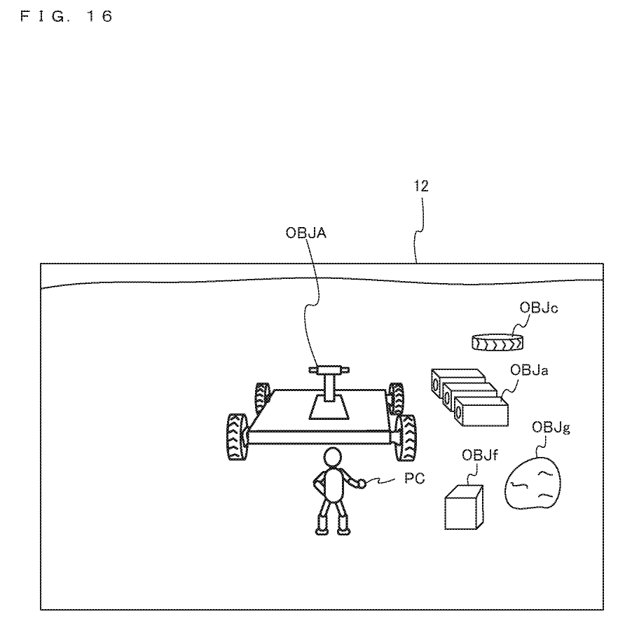

A process of causing an assembled object based on a recorded blueprint to appear in the virtual space will be described with reference to FIGS. 15 and 16. It should be noted that FIG. 15 is a diagram showing a non-limiting example of a game image in the game mode in which an assembled object is caused to appear in the virtual space. FIG. 16 is a diagram showing a non-limiting example of the game image in which an assembled object based on a recorded blueprint has been caused to appear in the virtual space.

In FIG. 15, a game image showing the virtual space including the player character PC is displayed on the display 12 of the game system 1. For example, the game image shows the virtual space as viewed from a virtual camera disposed behind the player character PC. The game image of FIG. 15 is displayed in an appearance mode in which an assembled object is caused to appear, where transition to the appearance mode is performed according to the user’s operation.

The game image shows blueprints selectable by the user and a blueprint currently selected as one to be caused to appear by the user. For example, in the non-limiting example of FIG. 15, a thumbnail of a blueprint D1 is displayed as one to be caused to appear, and thumbnails of blueprints D2 and D3 are displayed as other blueprints that are selectable. As a non-limiting example, the thumbnail of the blueprints D2 and D3 are grayed out and thereby displayed in a form different from that of the thumbnail of the blueprint D1, and are therefore distinguished from the thumbnail of the blueprint D1, which is one that is currently to be caused to appear. For example, the thumbnails of the blueprints D1–D3 are each an image acquired by simplifying an assembled object that appears using the respective blueprint. As a non-limiting example, the thumbnails of the blueprints D1–D3 are each an image acquired by reducing an image of the virtual space captured by the user in the recording process. As another non-limiting example, the thumbnails of the blueprints D1–D3 are each an image acquired by reducing an image of an assembled object to be recorded which is extracted from the captured image. In another non-limiting example, the thumbnails of the blueprints D1–D3 may be each an image acquired by reducing an image of an assembled object to be recorded which is captured in a predetermined direction, in addition to or instead of the above captured image.

For example, a plurality of blueprints selectable by the user are presented, each of which is generated based on an image of the virtual space captured by the user. As an assembled object (product) to be caused to appear is thus selected/set through image capture, the captured image (blueprint) itself can be set as an item to be selected, and therefore, amusingness emerges, and the user themselves can easily know what product is to appear, based on the thumbnail of the captured image (blueprint). It should be noted that for blueprints selectable by the user, at least a portion of blueprints currently recorded (stored) in the game system 1 may be presented as an option. The blueprints recorded in the game system 1 may include a blueprint created by another user. The blueprints recorded in the game system 1 may also include blueprints previously prepared by a designer or the like. In that case, the blueprints may be an item that can be acquired by the player character PC in the virtual space, or an item that is given to the player character PC when the player character PC clears a predetermined game event.

Here, as described above, the player character PC can temporarily store virtual objects or items. The virtual objects that the player character PC can temporarily store include a portion of the types of material objects that can constitute assembled objects. In the description that follows, material objects that the player character PC temporarily stores are referred to as “stored objects” and distinguished from other material objects. For example, a stored object may be one that is temporarily stored as a result of being picked up by the player character PC in the virtual space, or one that is newly stored into the player character PC when a predetermined event occurs. The thumbnail of the blueprint D1, which is one that is currently to be caused to appear, is accompanied by and displayed together with the stored objects currently stored by the player character PC that can be incorporated into the assembled object that is produced based on the blueprint D1. In the non-limiting example of FIG. 15, it is illustrated that the player character PC currently stores the wheel object OBJc and the control stick object OBJe, which can be incorporated into the assembled object indicated by the blueprint D1. It should be noted that the thumbnail of the blueprint D1, which is one that is currently to be caused to appear, may also be accompanied by and displayed together with numerical value information such as the number of stored objects that can be incorporated into the assembled object, the maximum number of material objects usable for the assembled object, and the minimum number of material objects currently required for the assembled object (e.g., the number acquired by subtracting the number of available material objects in a coverage area A described below in the virtual space from the maximum number).

It should be noted that the temporary storage of stored objects by the player character PC refers to carrying the stored objects without being attached to or held by the player character PC, for example. In this case, stored objects are not displayed in a game field. Stored objects can be brought out by the player character PC basically in an appropriate situation, and can be disposed in the game field, and used (e.g., attached or held). In the present non-limiting example, the player character PC stores stored objects in a container (e.g., a pouch or item box) attached to the body thereof. It should be noted that such a container may not be displayed. Such a container may not exist, and only the function of storing stored objects may exist.

When the user’s operation for transition to the appearance mode is performed, a coverage area A is displayed. The coverage area A is a range indicating which of the material objects disposed in the virtual space may be used for production of an assembled object that is currently to be caused to appear. It should be noted that a material object only a portion of which is included in the coverage area A may or may not be usable. For example, the coverage area A is set as a circular or elliptical range having a predetermined size around a position on the ground in front of the player character PC. The player character PC can automatically produce an assembled object to be caused to appear, using material objects disposed in the coverage area A of the material objects disposed in the virtual space, and cause the assembled object to appear in the virtual space.

In the present non-limiting example, only if an assembled object to be caused to appear can be completely assembled from stored objects of the player character PC and material objects disposed in the coverage area A, e.g., only if there are enough prepared material objects to constitute an assembled object to be caused to appear, the assembled object can be caused to appear. In the non-limiting example of FIG. 15, an assembled object that are assembled from four wheel objects OBJc, one board object OBJd, and one control stick object OBJe is to be caused to appear. Meanwhile, four wheel objects OBJc and one board object OBJd are disposed in the coverage area A, and the player character PC stores a control stick object OBJe as a stored object, and the assembled object can be completely assembled by putting these material objects together. Therefore, when the user’s operation of causing the assembled object to appear is performed, the assembled object appears.

It should be noted that as another non-limiting example, even when an assembled object to be caused to appear cannot be completely assembled using a stored object(s) of the player character PC and a material object(s) disposed in the coverage area A, e.g., there are not enough material objects for forming an assembled object to be caused to appear, a portion of the assembled object may be able to appear. For example, a portion of the assembled object may appear in a state in which the assembly of material objects excluding a lacking material object(s) is maintained. In that case, when there are not enough material objects for linking material objects, a small group state that can be only assembled using the material objects excluding a lacking material object(s) is caused to appear, or the material objects excluding a lacking material object(s) are caused to individually and separately appear in a distributed manner. As a non-limiting example, for an assembled object that is completely assembled by putting a material object A, a material object B, a material object C, a material object D, and a material object E together in this stated order, in the case in which the material object C is lacking, an assembled object acquired by putting the material object A and the material object B together and an assembly object acquired by putting the material object D and the material object E together are caused to appear. As another non-limiting example, for an assembled object that is completely assembled by putting a material object A, a material object B, and a material object C together in this stated order, in the case in which the material object B is lacking, the material object A and the material object C are each caused alone to move to a place where the material object A or C is to appear, and then appear separately.

In addition, in the game image, an expected completed model object is displayed for an assembled object currently designated as one to be caused to appear. For example, in the non-limiting example of FIG. 15, an expected completed model object M1 is displayed at a center of the coverage area A, e.g., on the ground in front of the player character PC. The expected completed model object M1 shows an expected shape of an assembled object that appears if the assembly thereof is completed based on the currently selected blueprint D1, in a display form (e.g., a framework object displayed in a translucent form) different from that of an actual assembled object. It should be noted that an expected completed model object disposed in the virtual space or an assembled object appearing in the virtual space based on the expected completed model object is disposed at a center of the coverage area A as described above, or alternatively, may be disposed at any position that allows at least a portion thereof to be present in the coverage area A.

In a first non-limiting example, the expected completed model object M1 is displayed, floating above the ground in the virtual space. In that case, an assembled object that is caused to appear based on the position and orientation of the expected completed model object M1 appears, floating above the ground, and then, falls down to the ground, and is disposed on the ground. In a second non-limiting example, in the case where another object is disposed on the ground of the virtual space in which the expected completed model object M1 is disposed, the expected completed model object M1 may be displayed above the second object with a predetermined space interposed therebetween. In either case, the expected completed model object M1 is displayed without a lower portion of the expected completed model object M1 overlapping with or being in contact with a portion of the ground or a portion of the second object. In a third non-limiting example, in the case where the coverage area A has no space in which the expected completed model object M1 can be disposed, e.g., there is another object (e.g., a wall provided at a center of the coverage area A or a roof provided at an upper portion of the coverage area A) that would penetrate into the expected completed model object M1 if the expected completed model object M1 were disposed in the virtual space, the expected completed model object M1 may not be displayed or may be grayed out so that the user is notified that the assembled object cannot be caused to appear.

The displayed position and displayed orientation of the expected completed model object M1 may be changeable according to the user’s operation. As a non-limiting example, once the expected completed model object M1 has been disposed and displayed in the virtual space, only the orientation of the expected completed model object M1 may be changeable according to the user’s operation. As another non-limiting example, the position of the expected completed model object M1 disposed and displayed in the virtual space may be changeable in the forward, backward, leftward, and rightward directions in the coverage area A according to the user’s operation, or the height (position in the upward and downward directions) thereof from the ground may be changeable in the coverage area A according to the user’s operation.

If every one of the material objects required for assembly of the expected completed model object M1 as an assembled object is present in the coverage area A and/or is among the stored objects, the display form of these material objects is changed (e.g., colored). Meanwhile, at least one of the material objects required for assembly of the expected completed model object M1 as an assembled object is not present in the coverage area A or is not among the stored objects, these material objects remain in a default display form (e.g., colorless and translucent). Therefore, all the material objects required for assembly of the expected completed model object M1 as an assembled object are displayed in a different form, depending on whether or not every one of these material objects is present in the coverage area A and/or is among the stored objects. Therefore, this allows the user to recognize whether or not there are enough material objects to complete an assembled object to be caused to appear. The expected completed model object M1 also allows the user to predict where an assembled object will appear in the virtual space.

It should be noted that even in the case where a material object required for completion of an assembled object may have a different appearance from that of a material object incorporated as a part in said assembled object, if the shapes of these material objects are substantially the same, these material objects may be handled as identical objects. For example, if the shapes of material objects are categorized in the same type (e.g., logs, rocks, weapons, and control sticks) and the shape similarity therebetween falls within a predetermined value, the material objects may be considered to be identical objects in the process of assembling an assembled object. As a non-limiting example, material objects whose surfaces have different appearances (e.g., different textures or colors) and that have the same shape (substantially the same shape) may be handled as identical objects. It should be noted that objects that are considered to have the same shape may be previously set, or alternatively, the similarity therebetween may be calculated, as appropriate, to determine whether or not the objects are identical to each other. In addition, the type of a material (e.g., wood or metal) for an object may be taken into account, and objects made of the same material may be handled as identical objects.

Of the material objects disposed in the virtual space, an object(s) that is to be used in the assembled object (an object that is used when the assembled object appears) is displayed in a different display form. For example, of the material objects in the coverage area A, a material object(s) that is to be used to complete an assembled object that is currently to be caused to appear is displayed in a different display form (e.g., colored). In the non-limiting example of FIG. 15, of the material objects in the coverage area A, four wheel objects OBJc and one board object OBJd that are to be used in an assembled object to be caused to appear are displayed in a different display form (in the non-limiting example of FIG. 15, those objects are indicated by hatching). This allows the user to recognize which of the material objects disposed in the virtual space is to be consumed in production of an assembled object.

It should be noted that if there are more material objects that can used to complete an assembled object to be caused to appear than necessary, a predetermined priority level may be set for each material object, and material objects may be consumed according to priority. As a non-limiting example, if there are more material objects disposed in the coverage area A than necessary, a material object located closer to the player character PC may be consumed with higher priority. As another non-limiting example, substantially the same object is present as a material object in the coverage area A and is among the stored objects, the material object disposed in the coverage area A may be consumed with higher priority.

Here, the material objects disposed in the virtual space include one that can be temporarily stored as a stored object by the player character PC, and one that cannot be temporarily stored as a stored object by the player character PC. A non-storable object that cannot be temporarily stored as a stored object by the player character PC may be a material object much bigger than the player character PC in the virtual space, or a material object for which there are a number of material objects having slightly different shapes and sizes (e.g., rocks, trees, etc.), or the like. In the present non-limiting example, examples of a non-storable object that cannot be temporarily stored as a stored object by the player character PC include a board object OBJd, a box object OBJf, a rock object OBJg, and a jewelry box object (not shown). It should be noted that examples of a material object that can be temporarily stored as a stored object by the player character PC include an engine object OBJa, a wheel object OBJc, and a control stick object OBJe.

It should be noted that at least a portion of an assembled object may be used as a material object in the virtual space that can be used in an assembled object to be caused to appear. For example, in the case where an assembled object already assembled is currently present in the coverage area A, a portion of the material objects constituting the assembled object may be used in order to cause a newly assembled object to appear. Specifically, at least a portion of an assembled object including a material object(s) that can be used in an assembled object to be caused to appear is disposed in the virtual space in the coverage area A, a material object(s) included in the assembled object disposed in the virtual space may be used in an assembled object to be caused to appear. When a material object that is a portion of an assembled object disposed in the virtual space is used, said material object is disconnected from the other objects in said assembled object and is lost, so that the other material objects fall down from the current position to the ground due to the disconnection and loss. It should be noted that any connection between the other material objects in the assembled object may be maintained.

In the foregoing, it is determined which of the material objects disposed in the coverage area A is used, without taking into consideration whether or not a material object is a portion of an assembled object. Specifically, as in the case where material objects are present as a separate object, a material object located closer to the player character PC may be used with higher priority, for example. It should be noted that in any case, the material objects disposed in the coverage area A are used with higher priority than at least that of stored objects. It should be noted that in another non-limiting example, material objects that are present as a separate object may be used with higher priority than that of material objects that are present as a portion of an assembled object. In still another non-limiting example, material objects that are present as a separate object may be used with the highest priority, stored objects may be used with the next highest priority, and material objects that are a portion of an assembled object may be used with the lowest priority.

The coverage area A may be set as a three-dimensional range in the virtual space. For example, the coverage area A may be defined as a circular or elliptical cylinder having a predetermined size. In that case, material objects disposed in the circular or elliptical cylinder that covers a predetermined height range above the player character PC may be selected as an object to be used in the coverage area A, or material objects disposed in the height range above the ground may be selected as an object to be used. It should be noted that the coverage area A set as a three-dimensional range may have a three-dimensional shape having a limit in the height direction, or not having a limit in the height direction (e.g., an infinite height).

In FIG. 16, when the user’s operation of causing an assembled object to appear is performed, the assembled object appears at a position and with an orientation at and with which the expected completed model object has been disposed. For example, in the non-limiting example of FIG. 16, the assembled object OBJA appears at the position in the virtual space where the expected completed model object M1 has been disposed, and with the orientation with which the expected completed model object M1 has been disposed. At this time, the material objects in the virtual space that were used to produce the appearing assembled object are removed from the virtual space in response to the appearance. It should be noted that when material objects are removed from the virtual space, a game scene in which the player character PC collects the material objects may be displayed. The stored objects that were used to produce the appearing assembled object are also removed from the stored objects of the player character PC. Here, it is assumed that the user’s operation of causing an assembled object to appear is enabled only if every one of the material objects required for completion of the assembled object is present in the coverage area A and/or is among the stored objects. In this case, only a completely assembled object can be caused to appear, and a not-completely assembled object cannot be caused to appear. It should be noted that the user’s operation of causing an assembled object to appear may be enabled even if there are not enough material objects to complete the assembled object in the coverage area A and the stored objects. In that case, a not-completely assembled object can be caused to appear.

It should be noted that the above material object removed from the virtual space may be used as at least a portion of an assembled object to be caused to appear. Here, in the case where a material object is used as at least a portion of an assembled object to be caused to appear, a material object in the coverage area A may be moved to an appropriate position in the assembled object to be put together with the assembled object, or alternatively, a material object may be temporarily removed from the coverage area A, and an assembled object having substantially the same material object may be caused to appear. In other words, the use of a material object as at least a portion of an assembled object to be caused to appear means not only that the material object is directly used, but also that the material object is temporarily removed from the virtual space, and substantially the same material object is used. As a non-limiting example, the process of using a material object may be implemented by either (a) or (b) described below.

(a) Removing material objects from the virtual space, putting polygon models different form the polygon models of the material objects together to produce an assembled object, and causing the assembled object to appear

(b) Causing an assembled object including at least a portion of the polygon models of material objects (specifically, an assembled object acquired by putting together polygon models including the polygon models of some material objects and the polygon models of other objects) to appear in a game field

Even in the case of the process (b), a scene can be displayed in which material objects are removed, and an assembled object is produced by putting said material objects and other objects together.

Thus, in the case where virtual objects disposed in the virtual space are used as a material for an assembled object, the maintenance of game aspects requires the user to have the right to possess or control the virtual objects. In the present non-limiting example, the user is allowed to specify the coverage area A covering positions where virtual objects are disposed, or move virtual objects into the coverage area A, whereby the user has the right to possess or control the virtual objects, and therefore, an assembled object including the virtual objects as a material can be produced with game aspects maintained. In the game field, terrains having various properties/shapes such as mountains, valleys, rivers, and seas are typically set, and therefore, an appearing assembled object may fail to be appropriately disposed in the virtual space. However, in the present non-limiting example, the virtual space region in which an assembled object appears is one in which material objects can be appropriately disposed, and therefore, an appearing assembled object is also highly likely to be appropriately disposed, and the possibility that an assembled object falls to be lost during appearance can be reduced, resulting in high usability.

### Second Non-Limiting Example

Next, a game in a second non-limiting example will be described. In the game in the second non-limiting example, an assembled object (product) is also produced by a player character PC putting a plurality of material objects OBJ together according to the user’s operation. Thereafter, the assembled object produced by the player character PC is automatically recorded as a blueprint of the assembled object. Here, a blueprint in the second non-limiting example is created based on an assembled object produced according to the user’s operation, and indicates an appearance of the assembled object based on the above design information. As in the first non-limiting example, in the second non-limiting example, a process of causing an assembled object based on a recorded blueprint to appear in a virtual space can also be carried out.

As a non-limiting example, a blueprint in the second non-limiting example is automatically recorded each time the player character PC puts material objects OBJ together. For example, when a material object A and a material object B are put together, a blueprint of an assembled product of the material object A and the material object B is automatically recorded. Thereafter, when a material object C is put together with the assembled product of the material object A and the material object B, a blueprint of an assembled product of the material object A, the material object B, and the material object C is automatically recorded separately from the blueprint of the assembled product of the material object A and the material object B. Therefore, in this case, the two blueprints that are the blueprint of the assembled product of the material object A and the material object B, and the blueprint of the assembled product of the material object A, the material object B, and the material object C, are recorded.

Here, in the game of the second non-limiting example, in addition to the above blueprint automatically recorded (hereinafter referred to as a “first type blueprint”), a blueprint of an assembled object corresponding to a predetermined item that is acquired in the game (hereinafter referred to as a “second type blueprint”) may be recorded. An upper limit may also be imposed on the possible number of recorded first type blueprints and the possible number of recorded second type blueprints. In that case, each time the player character PC puts material objects together, then if the upper limit for first type blueprints is exceeded by automatically recording a first type blueprint, one of the first type blueprint already recorded that was recorded at a relatively early time (a relatively early recorded one) is automatically deleted. When the player character PC obtains the predetermined item, and a second type blueprint relating to the item is recorded, then if the upper limit for second type blueprints is exceeded, one of the second type blueprints already recorded that was selected according to the user’s operation or was recorded at a relatively early time is deleted.

In addition, in a game of the second non-limiting example, a blueprint of an assembled object received from the server 200 by a communication process described below (hereinafter referred to as a “third type blueprint”) may be recorded. As a first non-limiting example, an upper limit (e.g., 30) may be imposed on the possible total number of the first type blueprints, the second type blueprints, and the third type blueprints. In that case, when the possible total number is exceeded by recording of any of the first type blueprint, the second type blueprint, and the third type blueprint into the game system 1, one of the first type blueprints, the second type blueprints, and the third type blueprints that was recorded at a relatively early time is automatically deleted. As a second non-limiting example, an upper limit may be imposed on each of the possible number of the first type blueprints, the possible number of the second type blueprints, and the possible number of the third type blueprints. In that case, when one of the first type blueprint, the second type blueprint, and the third type blueprint is recorded into the game system 1, then if the upper limit of the corresponding possible number is exceeded, one that was recorded at a relatively early time is automatically deleted from the first type blueprints, the second type blueprints, or the third type blueprints that exceed the upper limit.

Such automatic deletion may not be performed. To that end, a specific blueprint (hereinafter referred to as a “fourth type blueprint”) may be set from the first, second, and third type blueprints. As a non-limiting example, a “preferred” blueprint may be selected and set from the first, second, and third type blueprints according to the user’s operation, and may thereby be recorded as the fourth type blueprint. Due to the above recording process, the record of the fourth type blueprint is maintained even when the upper limit of the number of recorded blueprints is exceeded by recording any type of blueprint. It should be noted that an upper limit may be imposed on the possible number of recorded fourth type blueprints. When the user records a new fourth type blueprint, then if the upper limit for fourth type blueprints is exceeded, one of the fourth type blueprints already recorded is selected and deleted according to the user’s operation.

It should be noted that when the fourth type blueprint is selected and recorded from the first, second, and third type blueprints, the selected blueprint may be changed to a fourth type blueprint (e.g., the blueprint is moved and recorded from the list of recorded first type blueprints, the list of recorded second type blueprints, or the list of recorded third type blueprints to the list of recorded fourth type blueprints), or the selected blueprint may be duplicated as a fourth type blueprint (e.g., the blueprint is copied and recorded from the list of recorded first type blueprints, the list of recorded second type blueprints, or the list of recorded third type blueprints to the list of recorded fourth type blueprints). In the latter case, the blueprint of an assembled object recorded as a fourth type blueprint may be deleted as the first, second, or third type blueprint by the above deletion process, but continues to be recorded as a fourth type blueprint.

The first type blueprint may not be automatically recorded as described above when the player character PC separates a material object from an assembled object. For example, when a material object C is selected and separated from an assembled object of a material object A, a material object B, the material object C, a material object D, and a material object E (A-B-C-D-E) to separate the assembled object into the material object A and the material object B (A-B), the material object C (C), and the material object D and the material object E (D-E), an assembled object of the material object A and the material object B (A-B) and an assembled object of the material object D and the material object E (D-E) are acquired. However, if such separated assembled products are automatically recorded as a first type blueprint each time such separation occurs, the upper limit of the possible number of recorded blueprints is relatively quickly reached, and blueprints that the user does not desire to record may be recorded. If such separated assembled objects are not automatically recorded as a first type blueprint, the above situation can be avoided.

As another non-limiting example, the user’s operation indicating completion of an assembled object may trigger recording of the blueprint of the assembled object as a first type blueprint. In that case, when the blueprint of an assembled object is newly recorded as a first type blueprint, the user is notified of an image showing the recorded blueprint indicating the assembled object, and of information indicating recording of the blueprint, by means of text, sound, or the like.

No upper limit may be imposed on the possible number of recorded second type blueprints. In that case, for example, second type blueprints can be recorded without a limit when a predetermined number of predetermined items prepared in the game are acquired, and may not be deleted according to the user’s operation or automatically. As a result, in the case where the blueprint of an assembled object that is a rare second type blueprint can be acquired, a situation that the user accidentally deletes that blueprint can be avoided.

In a non-limiting embodiment, the game of the first non-limiting example and the game of the second non-limiting example may be combined together as appropriate. In a first non-limiting preferred example, the second or third type blueprint of the second non-limiting example may be recorded in the game of the first non-limiting example. In a second non-limiting preferred example, a specific blueprint selected from blueprints recorded by performing an operation of capturing a game image in the first non-limiting example may also be recorded as a fourth type blueprint of the second non-limiting example. In a third non-limiting preferred example, a game may be played in which both a blueprint recorded by performing an operation of capturing a game image in the first non-limiting example and a first type blueprint automatically recorded in the second non-limiting example can be recorded.

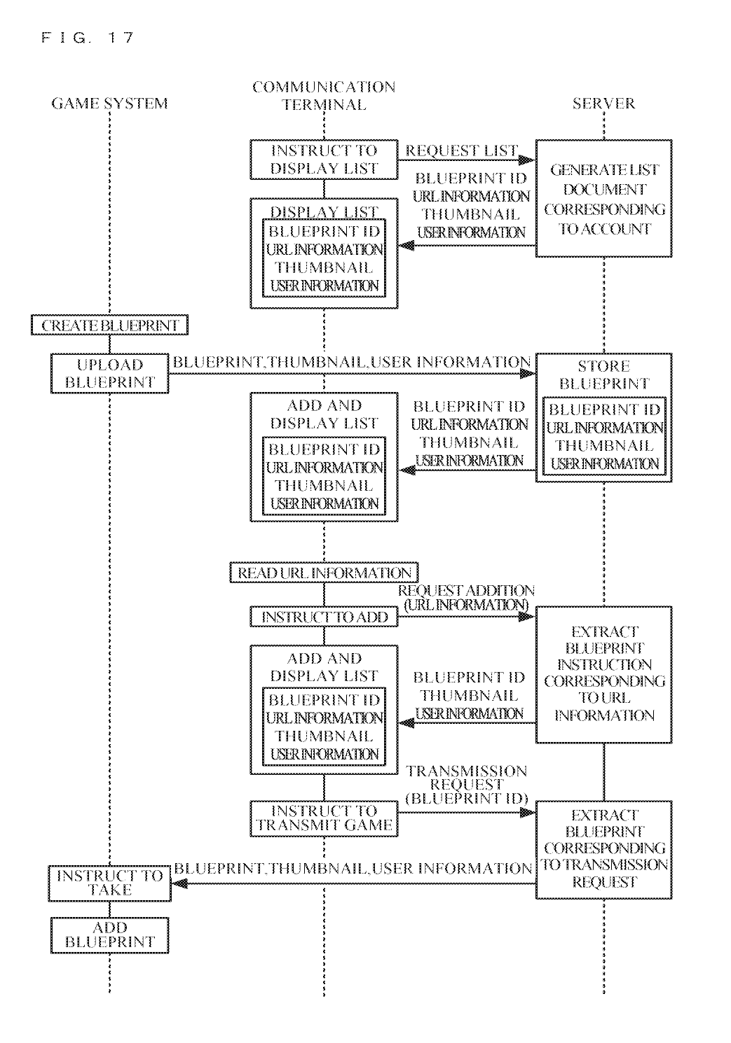

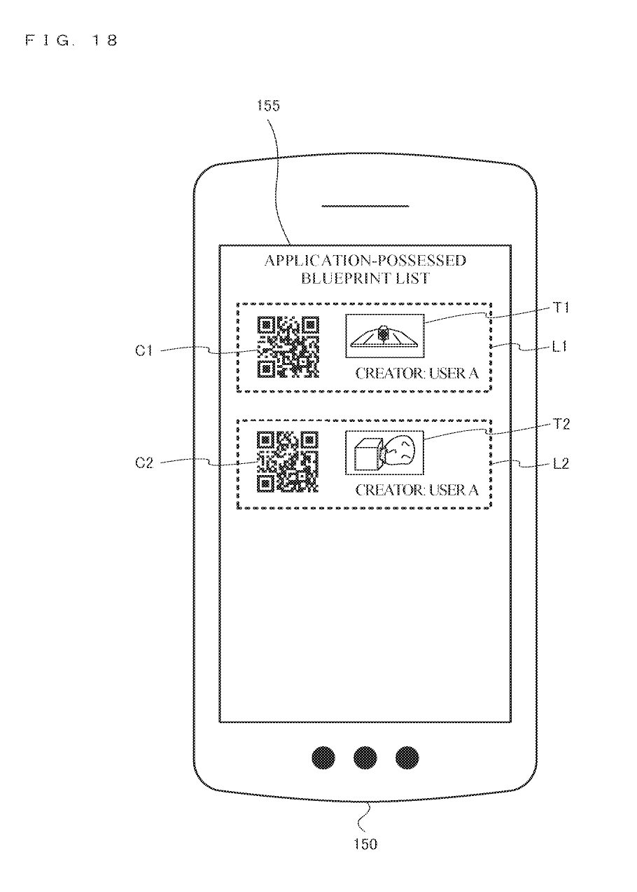

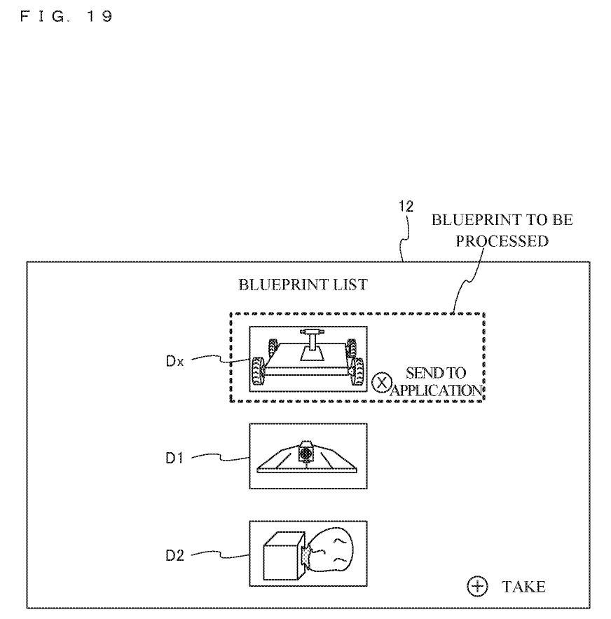

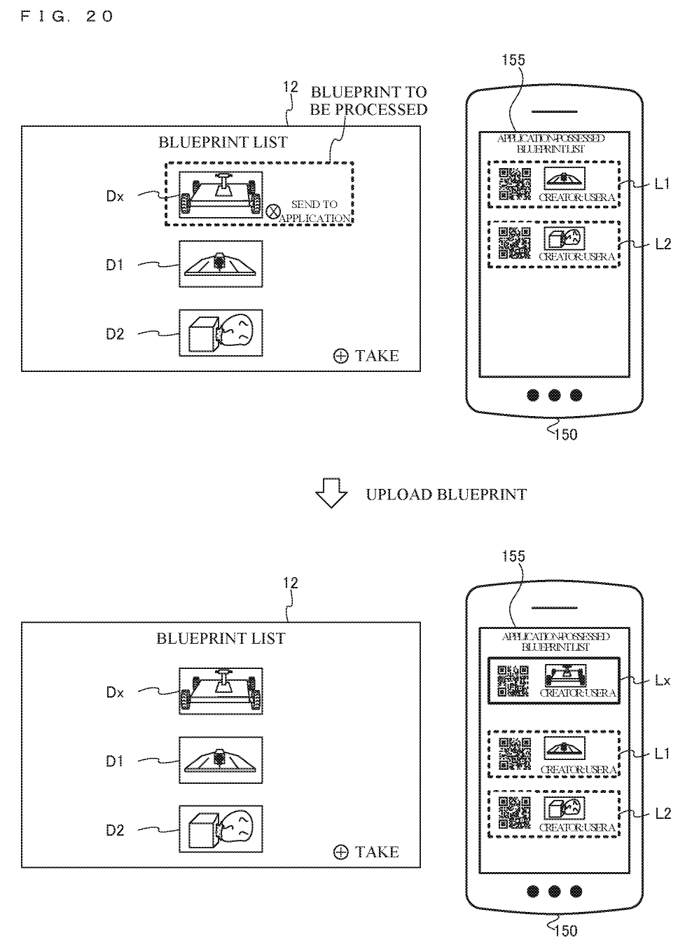

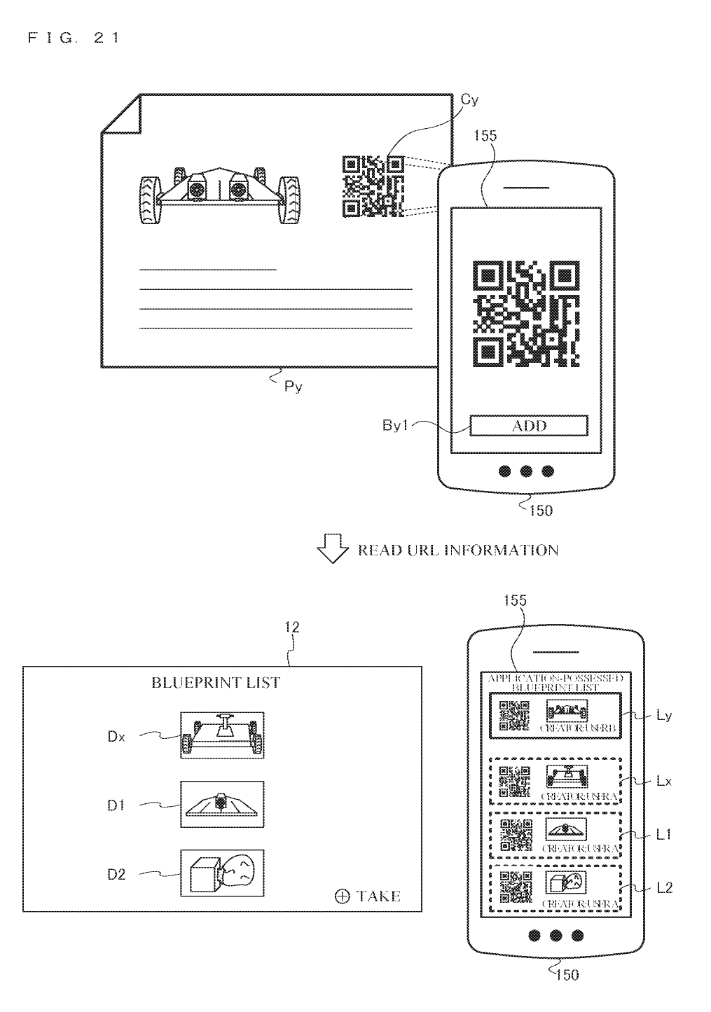

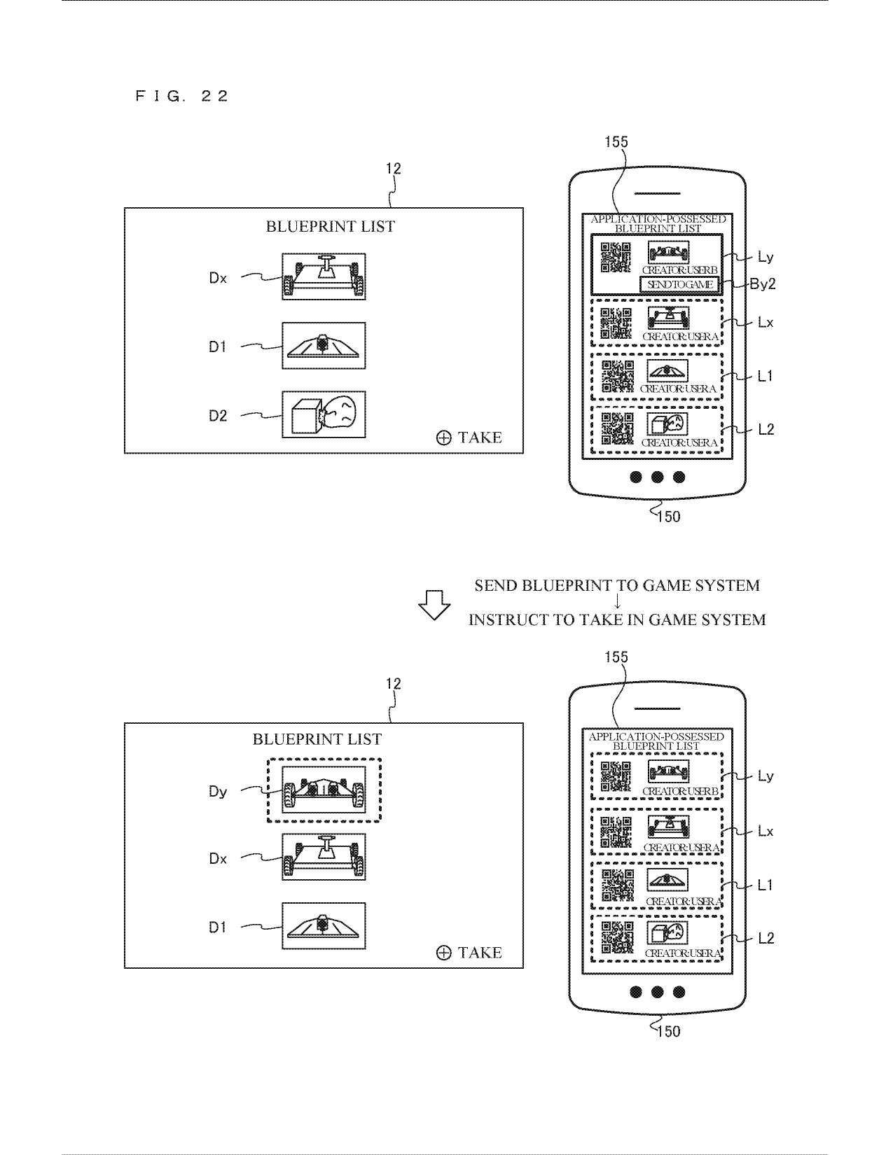

Next, a non-limiting example of a communication process in which blueprints are exchanged using the communication system 100 including the game system 1, the communication terminal 150, and the server 200 will be described with reference to FIGS. 17–22. FIG. 17 is a sequential diagram showing a non-limiting example of a communication process operation between the game system 1, the communication terminal 150, and the server 200. FIG. 18 is a diagram showing a non-limiting example of an application-possessed blueprint list displayed on the display section 155 of the communication terminal 150. FIG. 19 is a diagram showing a non-limiting example of a blueprint list displayed on the display 12 of the game system 1. FIG. 20 is a diagram showing a non-limiting example of an image displayed on each of the display 12 of the game system 1 and the display section 155 of the communication terminal 150 when a blueprint is downloaded from the game system 1. FIG. 21 is a diagram showing a non-limiting example of an image displayed on each of the display 12 of the game system 1 and the display section 155 of the communication terminal 150 when uniform resource locator (URL) information Cy is read in the communication terminal 150. FIG. 22 is a diagram showing a non-limiting example of an image displayed on each of the display 12 of the game system 1 and the display section 155 of the communication terminal 150 when a blueprint is transmitted from the communication terminal 150 to the game system 1.

In the sequence shown in FIG. 17, the game system 1 and the communication terminal 150 are operated by the same user with the game system 1 and the communication terminal 150 logging in the server 200 using the same account. Therefore, the server 200 recognizes that the game system 1 and the communication terminal 150 are being used by the same user.

In such a state, when an operation of the user of the communication terminal 150 for displaying an application-possessed blueprint list on the display section 155 and a process of displaying the list (e.g., a process of updating the displayed list) is performed to provide an instruction to display the list, a request for acquiring the document of the application-possessed blueprint list is provided from the communication terminal 150 to the server 200. Here, the application-possessed blueprint list indicates a list of blueprints possessed in an application that is being executed by the communication terminal 150. The communication terminal 150 provides a request for acquiring the document in order to display the list.

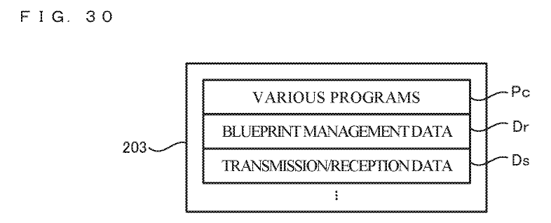

The server 200, when receiving the request for acquiring the document of an application-possessed blueprint list, creates the document of an application-possessed blueprint list corresponding to the account of the sender of the acquisition request, and transmits the document to the communication terminal 150 as a destination. For example, the server 200 extracts blueprint information (e.g., a blueprint ID, URL information, a thumbnail, and the creator’s user information) that is managed in blueprint management data Dr (see FIG. 30) stored in the storage section 203 and corresponds to the account, and creates the extracted blueprint information as the document of an application-possessed blueprint list.

The communication terminal 150 uses the received data of the application-possessed blueprint list to display the application-possessed blueprint list on the display section 155. As shown in FIG. 18, the display section 155 of the communication terminal 150 displays an application-possessed blueprint list indicating a list of blueprint information L corresponding to each of a plurality of blueprints ID, e.g., two pieces of blueprint information L1 and L2. Here, a blueprint ID is identification information of a blueprint for transmitting and receiving blueprint information between the communication terminal 150 and the server 200. A unique blueprint ID corresponding to each blueprint managed in the server 200 is created in the server 200 or the game system 1. For example, the blueprint information L1 includes at least a thumbnail T1 and URL information C1. The thumbnail T1 is an image associated with the blueprint corresponding to a blueprint ID1. For example, the thumbnail T1 is created by reducing an image captured when the blueprint is recorded into the game system 1 as described above (see FIGS. 14 and 15), and is displayed together with information about the user that has created the blueprint. The URL information C1 is for accessing the blueprint information L1, and indicates the position on the network 300 of the blueprint information L1. The URL information C is displayed as, for example, a two-dimensional barcode such as a quick response (QR) code (registered trademark), and the display form thereof is not particularly limited. For example, the URL information C may be displayed in the form of a one-dimensional barcode or text information that describes a communication standard (protocol).

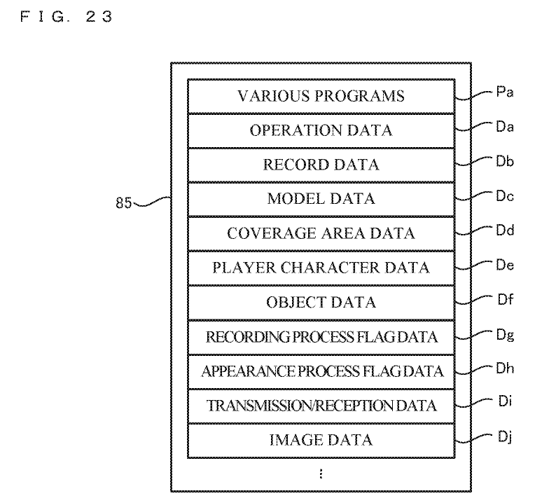

Referring back to FIG. 17, when an operation input for uploading a blueprint created and recorded in the game system 1 is performed in the game system 1, data related to the blueprint is uploaded from the game system 1 to the server 200. As shown in FIG. 19, a blueprint list is displayed on the display 12 of the game system 1 based on the user’s operation for displaying the blueprint list on the display 12 and a process of displaying the list. For example, the blueprint list is an image showing a list of blueprints currently possessed by the game system 1. Thumbnails corresponding to the respective blueprints D are arranged and displayed on the display 12 using record data Db (see FIG. 23) in the DRAM 85 of the game system 1. In the non-limiting example shown in FIG. 19, a blueprint list is displayed in which thumbnails corresponding to a blueprint Dx and blueprints D1 and D2 are arranged in the vertical direction. In addition, the blueprint Dx is displayed in a display form that indicates that the blueprint Dx is currently set as one to be processed. The thumbnail corresponding to the blueprint Dx is displayed together with operation information for transmitting the blueprint Dx to an application (e.g., information indicating that a blueprint is transmitted to an application by operating the X-button (operation button 55)). In addition, in the non-limiting example shown in FIG. 19, operation information for receiving a blueprint (e.g., information indicating that a blueprint is received by operating the “+” button (operation button 57)) is displayed, which is described below in detail.

When the user’s operation for transmitting the blueprint Dx from the game system 1 to an application, the game system 1 transmits data indicating the blueprint Dx to the server 200. For example, the data indicating the blueprint Dx includes data of the blueprint Dx, the thumbnail of the blueprint Dx, the user information (e.g., the user ID and the user name) of the game system 1, and the like. As described above, the thumbnail of the blueprint Dx is an image acquired by reducing a captured image generated by imaging a virtual space when the blueprint Dx is recorded, for example.

The server 200, when receiving the uploaded blueprint Dx, adds the blueprint Dx as a blueprint corresponding to the account of the sender uploading the blueprint Dx, and updates the blueprint management data Dr stored in the storage section 203. For example, the server 200 sets a unique blueprint ID with respect to the uploaded blueprint Dx. In addition, the server 200 sets a URL indicating the place where the uploaded blueprint Dx is stored and managed in the storage section 203, and sets URL information indicating the URL. The server 200 adds a set of the uploaded blueprint Dx, the blueprint ID, the URL information, and the uploaded thumbnail and user information, as a blueprint corresponding to the account of the sender uploading the blueprint Dx, to the blueprint management data Dr. It should be noted that the blueprint ID may be set in the game system 1. In that case, the blueprint ID is uploaded from the game system 1 to the server 200.

The server 200 transmits information about the added blueprint Dx to the communication terminal 150 of the account related to the addition. For example, the information about the added blueprint Dx includes the blueprint ID, URL information, thumbnail, user information, and the like of the added blueprint Dx.

The communication terminal 150, when receiving information about the added blueprint Dx from the server 200, adds the information about the added blueprint Dx to list data Dn of the storage section 152, thereby updating the application-possessed blueprint list. For example, the communication terminal 150 adds the information about the blueprint Dx received from the server 200 (the blueprint ID, URL information, thumbnail, user information, and the like of the blueprint Dx) as information about a blueprint newly possessed in an application that is being executed by the communication terminal 150. When an operation of the user of the communication terminal 150 for displaying the application-possessed blueprint list on the display section 155 is performed and a process of displaying the list (e.g., a process of updating the displayed list) is executed, the updated application-possessed blueprint list is displayed on the display section 155. For example, as with the blueprint information L already recorded, the added blueprint Dx is added to and displayed on the application-possessed blueprint list as blueprint information Lx including at least a thumbnail and URL information included in the information about the blueprint Dx received from the server 200.

In the non-limiting example shown in the upper diagram of FIG. 20, a blueprint list currently possessed by the game system 1 is displayed on the display 12 of the game system 1, indicating that the blueprint Dx is currently set as one to be processed. In addition, an application-possessed blueprint list indicating that information about a blueprint possessed in an application currently executed by the communication terminal 150 is the blueprint information L1 and L2 is displayed on the display section 155 of the communication terminal 150.

In the non-limiting example shown in the lower diagram of FIG. 20, in the game system 1, when the user’s operation for uploading the blueprint Dx is performed, an application-possessed blueprint list indicating that the blueprint information Lx has been added is displayed on the display section 155 of the communication terminal 150. Thus, in the present non-limiting example, when a blueprint is uploaded from the game system 1, data related to the blueprint uploaded to the server 200 is stored, and an application-possessed blueprint list displayed in the communication terminal 150 also indicates that the blueprint has been added, so that the user can confirm that the blueprint has been uploaded to the server 200, and subsequently can also check a state of the blueprint, which is managed with respect to the user’s account in the server 200.

Referring back to FIG. 17, when URL information is read in the communication terminal 150, the communication terminal 150 sends, to the server 200, a request for acquiring blueprint information corresponding to the URL information. For example, when an image captured by the imaging unit 157 includes an image showing URL information Cy (e.g., a QR code (registered trademark)), the control section 151 of the communication terminal 150 reads the contents of the image to acquire the URL information Cy. When the user of the communication terminal 150 performs an operation for adding blueprint information corresponding to the URL information Cy, the communication terminal 150 sends, to the server 200, a request for acquiring blueprint information corresponding to the URL information Cy, based on the URL information Cy.

The server 200, when receiving the blueprint information acquisition request based on the URL information Cy, extracts blueprint information Ly corresponding to the URL information Cy from the blueprint management data Dr stored in the storage section 203. Thereafter, the server 200 adds the extracted blueprint information Ly as blueprint information L corresponding to the account of the sender of the request, and updates the blueprint management data Dr stored in the storage section 203. For example, the server 200 adds a set of a blueprint Dy contained in the extracted blueprint information Ly, and the blueprint ID, URL information Cy, thumbnail, and user information of the blueprint Dy, as a blueprint corresponding to the account of the sender of the request, to the blueprint management data Dr.

Thereafter, the server 200 transmits information about the added blueprint Dy to the communication terminal 150 of the account related to the addition. For example, the information about the added blueprint Dy contains the blueprint ID, thumbnail, user information, and the like of the added blueprint Dy. It should be noted that the information about the added blueprint Dy, which is transmitted from the server 200, may contain the URL information Cy that has been used in reading and acquiring the blueprint Dy.

The communication terminal 150, when receiving the information about the added blueprint Dy from the server 200, adds the information about the added blueprint Dy to the list data Dn of the storage section 152, thereby updating the application-possessed blueprint list. For example, the communication terminal 150 adds the information about the blueprint Dy that has been received from the server 200 (the blueprint ID, thumbnail, user information, and the like of the blueprint Dy) and the URL information Cy that has been used in reading and acquiring the blueprint Dy, as information about a blueprint newly possessed in an application that is being executed by the communication terminal 150. Thereafter, when an operation of the user of the communication terminal 150 for displaying the application-possessed blueprint list on the display section 155 is performed and a process of displaying the list (e.g., a process of updating the displayed list) is executed, the updated application-possessed blueprint list is displayed on the display section 155. For example, as with the blueprint information L already recorded, the added blueprint Dy is added to and displayed on the application-possessed blueprint list as the blueprint information Ly containing at least the thumbnail and URL information contained in the information about the blueprint Dy received from the server 200.

In the non-limiting example shown in the upper diagram of FIG. 21, a document Py on which a thumbnail of the blueprint Dy associated with the URL information Cy is printed together with an image indicating the URL information Cy (e.g., a QR code (registered trademark)) is imaged by the imaging unit 157 of the communication terminal 150. By this imaging process, an operation button By1 on which a touch operation is performed in order to add the blueprint Dy corresponding to the URL information Cy is displayed together with an image including the URL information Cy that has been captured by the imaging unit 157 on the display section 155 of the communication terminal 150. In addition, the control section 151 of the communication terminal 150 reads the contents of the image captured by the imaging unit 157 to acquire the URL information Cy. Thereafter, when the user of the communication terminal 150 performs a touch operation on the operation button By1, the communication terminal 150 sends a request for acquiring blueprint information corresponding to the URL information Cy to the server 200 based on the URL information Cy.

In the non-limiting example shown in the lower diagram of FIG. 21, when a process of reading an image showing the URL information Cy is executed in the communication terminal 150, the application-possessed blueprint list indicating the addition of the blueprint information Ly is displayed on the display section 155 of the communication terminal 150. Thus, in the present non-limiting example, when an image showing URL information is read in the communication terminal 150, a blueprint corresponding to URL information read by the server 200 is managed as a new blueprint corresponding to the account of the user that has performed the reading, and the application-possessed blueprint list displayed in the communication terminal 150 indicates the addition of the blueprint. Therefore, the user can confirm that a blueprint corresponding to the read URL information has been newly acquired.

Referring back to FIG. 17, when an operation for transmitting the added blueprint to the game system 1 is performed, the communication terminal 150 sends, to the server 200, a request for transmitting the blueprint corresponding to the blueprint ID to the game system 1, based on the blueprint ID corresponding to the blueprint.

The server 200, when receiving the request for transmitting the blueprint corresponding to the blueprint ID to the game system 1, extracts the blueprint information Ly of the blueprint Dy corresponding to the blueprint ID from the blueprint management data Dr stored in the storage section 203. Thereafter, the server 200 transmits a set of the blueprint Dy contained in the extracted blueprint information Ly, and the thumbnail and user information of the blueprint Dy, to the game system 1 corresponding to the account of the sender of the request.

The game system 1 receives the set of the blueprint Dy and the thumbnail and user information of the blueprint Dy from the server 200, and notifies the user of the game system 1 of the reception using an image or sound (e.g., speech). Thereafter, when the user of the game system 1 performs an operation for taking the received blueprint, the game system 1 adds data based on the received blueprint to the record data Db stored in the DRAM 85. For example, the game system 1 adds a new blueprint to the record data Db using the blueprint Dy, thumbnail, and user information received from the server 200. As a result, the blueprint list displayed on the display 12 of the game system 1 indicates that the blueprint Dy has been newly added.

In the non-limiting example shown in the upper diagram of FIG. 22, blueprints D1, D2, and Dx currently possessed by the game system 1 are displayed in the form of a blueprint list on the display 12 of the game system 1. In addition, an application-possessed blueprint list indicating that information about blueprints possessed in an application currently executed by the communication terminal 150 is blueprint information L1, L2, Lx, and Ly is displayed on the display section 155 of the communication terminal 150. On the display section 155 of the communication terminal 150, displayed is an operation button By2 on which a touch operation is performed in order to transmit the blueprint Dy corresponding to the blueprint information Ly of interest to the game system 1. When the user of the communication terminal 150 performs a touch operation on the operation button By2, the communication terminal 150 transmits, to the server 200, a request for transmitting the blueprint Dy corresponding to the blueprint information Ly to the game system 1.

In the non-limiting example shown in the lower diagram of FIG. 20, in the game system 1, when the user’s operation for taking the blueprint Dy transmitted from the server 200 is performed, the blueprint Dy is added to the blueprint list displayed on the display 12 of the game system 1. Thus, in the present non-limiting example, a blueprint that has been newly added in an application that is being executed by the communication terminal 150, by the communication terminal 150 reading an image showing URL information, can be added as a new blueprint that can be used in a game in the game system 1 when the user’s operation for transmitting the blueprint to the game system 1 is performed in the communication terminal 150 and the user’s operation for taking the blueprint is performed in the game system 1. Therefore, in the present non-limiting example, based on transmission and reception of a blueprint, an assembled object generated by a user in a game can be shared with another user. For example, when the communication terminal 150 of a user reads an image of URL information associated with an assembled object generated by another user, a blueprint needed to generate the assembled object can be acquired in the game system 1, and therefore, the blueprint is more easily shared between the users.

It should be noted that even in the case in which a blueprint is transmitted and received using the communication system 100, an upper limit may be imposed on the number of blueprints that can be recorded in the game system 1 and the number of blueprints that can be managed in the communication terminal 150. For example, in the game system 1, an upper limit (e.g., an upper limit value of 30) may be imposed on a possible record number that is the sum of the number of blueprints recorded in a game of the first or second non-limiting example and the number of blueprints received from the server 200 and recorded. In that case, as a first non-limiting example, if in the game system 1, the upper limit of the possible record number is exceeded when a blueprint is newly recorded, one of blueprints already recorded (e.g., one of blueprints recorded in the game and blueprints received from the server 200 and recorded) that was recorded at a relatively early time may be automatically deleted. As a second non-limiting example, if the upper limit of the possible record number is exceeded when a blueprint is newly recorded in the game system 1, one of blueprints already recorded in the game that was recorded at a relatively early time may be automatically deleted. As a third non-limiting example, if the upper limit of the possible record number is exceeded when a blueprint is newly recorded in the game system 1, one of blueprints already received from the server 200 and recorded that was recorded at a relatively early time may be automatically deleted.

In addition, in the game system 1, an upper limit may be imposed on each of the possible record number of blueprints recorded in the game of the first or second non-limiting example and the possible record number of blueprints received from the server 200 and recorded. In that case, in the game system 1, if the number of blueprints in the game of the first or second non-limiting example exceeds the upper limit of the possible record number, one of the blueprints already recorded in the game that was recorded at a relatively early time may be automatically deleted, and when the number of blueprints received from the server 200 and recorded exceeds the upper limit of the possible record number, one of the blueprints received and recorded that was recorded at a relatively early time may be automatically deleted.

In addition, an upper limit may be imposed on the number of blueprints that can be managed by the communication terminal 150 in an application that is being executed by the communication terminal 150 (referred to as a “possible management number”). As a first non-limiting example, if the upper limit of the possible management number is exceeded when a blueprint managed in an application that is being executed by the communication terminal 150 is newly added, one of blueprints already managed that started to be managed at a relatively early time may be automatically deleted. As a second non-limiting example, if the upper limit of the possible management number is exceeded when a blueprint managed in an application that is being executed by the communication terminal 150 is newly added, one of blueprints acquired by the communication terminal 150 reading URL information that was recorded at a relatively early time may be automatically deleted, or one of blueprints acquired by uploading of the game system 1 that started to be managed at a relatively early time may be automatically deleted.

In addition, an upper limit may be imposed on each of the number of blueprints that can be acquired by the communication terminal 150 reading URL information and the number of blueprints that can be uploaded and acquired by the game system 1 (each referred to as a “possible management number”). In that case, if the upper limit of the possible management number is exceeded by the number of blueprints acquired by the communication terminal 150 reading URL information, one of blueprints already read and managed that started to be managed at a relatively early time may be automatically deleted, and if the upper limit of the possible management number is exceeded by the number of blueprints uploaded and acquired by the game system 1, one of blueprints already uploaded and managed that started to be managed at a relatively early time may be automatically deleted.

It should be noted that the upper limit of the possible management number in the communication terminal 150 (e.g., an upper limit value of 60) may be set to a value higher than the upper limit value of the possible record number in the game system 1 (e.g., an upper limit value of 30). As a result, it is possible to substantially avoid the situation in which a large number of blueprints are recorded in the game system 1, so that it takes a long period of time to select one from the blueprints. In addition, by relatively increasing the possible management number in the communication terminal 150, the user’s desire to possess as many blueprints as possible can be satisfied, which promotes the use of the blueprint management system employing the communication terminal 150.

Thus, in the game system 1 or the communication terminal 150, when the upper limit of the possible record number or the possible management number is exceeded, a blueprint is automatically deleted. Therefore, the storage capacities of the game system 1 and the communication terminal 150 can be prevented from being accidentally limited. In addition, since the user may desire to regenerate or duplicate a newly generated assembled object, a system having excellent usability can be provided by automatically deleting a relatively old product.

In addition, in order to avoid such automatic deletion, a blueprint that is not to be deleted from blueprints recorded in the game system 1 may be able to be set, or a blueprint that is not to be deleted from blueprints managed in the communication terminal 150 may be able to be set. As a non-limiting example, in the game system 1, a “preferred” blueprint may be selected and set from blueprints already recorded in the game system 1 according to the user’s operation, so that the blueprint that is not to be deleted may be set. By this setting process, even when a blueprint is newly recorded, so that the upper limit of the possible record number in the game system 1 is exceeded, the blueprint that is not to be deleted continues to be recorded in the game system 1. It should be noted that an upper limit may be imposed on the number of blueprints that can be set as one that is not to be deleted in the game system 1 (referred to as a “possible setting number”). In that case, if the upper limit of the possible setting number is exceeded when the user of the game system 1 newly sets a blueprint that is not to be deleted, one of blueprints already set as one that is not to be deleted, that has been selected according to the user’s operation, may be deleted.

It should be noted that when a blueprint that is not to be deleted is selected and set from blueprints recorded in the game system 1, the selected blueprint may be changed to a blueprint that is not to be deleted (e.g., a blueprint may be moved from a record list of blueprints recorded in the game system 1 to a setting list of blueprints that are not to be deleted, and may be set), or a selected blueprint may be duplicated as a blueprint that is not to be deleted (e.g., a blueprint is copied from a record list of blueprints recorded in the game system 1 to a setting list of blueprints that are not to be deleted, and is set). In the latter case, although a blueprint of an assembled object that is set as a blueprint that is not to be deleted, may be deleted as a blueprint recorded in the game system 1 by the above removal process, the blueprint continues to be recorded as a blueprint that is not to be deleted.

As another non-limiting example, when a “preferred” blueprint is selected and set from blueprints already managed in the communication terminal 150 according to the user’s operation in the communication terminal 150, the blueprint that is not to be deleted may be set. By this setting process, management of the blueprint that is not to be deleted is maintained in the communication terminal 150 even when the upper limit of the possible management number in the communication terminal 150 is exceeded, and a blueprint starts to be newly managed. It should be noted that an upper limit may be imposed on the possible setting number of blueprints that are not to be deleted in the communication terminal 150. In that case, if the upper limit of the possible setting number is exceeded when the user of the communication terminal 150 newly sets a blueprint that is not to be deleted, one of blueprints already set as one that is not to be deleted may be selected and deleted according to the user’s operation.

It should be noted that when a blueprint that is not to be deleted is selected and set from blueprints managed in the communication terminal 150, the selected blueprint may be changed to a blueprint that is not to be deleted (e.g., a blueprint is moved from a management list of blueprints managed in the communication terminal 150 to a setting list of blueprints that are not to be deleted, and is set), or the selected blueprint may be duplicated as a blueprint that is not to be deleted (e.g., a blueprint is copied from a management list of blueprints managed in the communication terminal 150 to a setting list of blueprints that are not to be deleted, and is set). In the latter case, a blueprint of an assembled object set as a blueprint that is not to be deleted may be deleted as a blueprint managed in the communication terminal 150 by the above deletion process, and continues to be managed as a blueprint that is not to be deleted.

Thus, in the game system 1 and the communication terminal 150, a blueprint that is not to be automatically deleted is set, and therefore, a blueprint that the user does not refuse to delete is automatically deleted while a blueprint that the user does not desire to delete continues to be set, resulting in a system having excellent usability.

Neither an upper limit nor a management limit may be imposed on the number of blueprints managed in the server 200. Alternatively, an upper limit and/or a management limit may be imposed thereon. In the former case, a blueprint that has no longer been possessed in an account continues to be managed in the server 200, and a blueprint associated with URL information set in the server 200 continues to be managed without being deleted, and therefore, the user of the server 200 can use a blueprint associated with URL information at any time. In the latter case, blueprint data that started to be managed at a relatively early time may be deleted when the number of blueprints managed in the server 200 exceeds the upper limit, and blueprint data for which the management start time violates the management limit may be deleted in the server 200. In that case, the storage capacity of the server 200 can be prevented from being exceeded.

In addition, in the above non-limiting example, an image showing URL information (e.g., a two-dimensional barcode) is created in the server 200 and transmitted to the communication terminal 150. Alternatively, the image may be created in the communication terminal 150. In that case, the communication terminal 150 receives URL information from the server 200, and can create an image showing the URL information in a form depending on the processing capability and reading capability of the communication terminal 150.

In addition, in the above non-limiting example, a blueprint corresponding to each account is managed in the server 200. Alternatively, a process of managing a blueprint may be executed in the communication terminal 150. In that case, of the data related to blueprints that is stored in the server 200, data related to a blueprint associated with the account of each communication terminal 150 may be stored in that communication terminal 150. In that case, a communication system may be configured in which the above blueprint is transmitted and received without via the server 200. Data transmission/reception between a game system 1 (main body apparatus 2) and a communication terminal 150 that have the same account or data transmission/reception between communication terminals 150 having other accounts may be performed by peer-to-peer (PtoP) communication or local communication, whereby the communication system is implemented.

In addition, although in the above non-limiting example, the user of the game system 1 can use a game while sharing a blueprint with another user, the form in which a blueprint is used is not limited to sharing of a blueprint. For example, even when a blueprint that the user of the game system 1 has uploaded to the server 200 is deleted from the game system 1, the user can receive the blueprint from the server 200 again in the game system 1. Therefore, the user of the game system 1 can also use the server 200 as a data storage device that temporarily stores a blueprint recorded in the game system 1. In that case, even in a communication system in which the game system 1 (main body apparatus 2) or the communication terminal 150 of another user is not connected to the server 200, the effect of the communication system can be acquired, and even when a blueprint created by another user is not used, the effect of the communication system can be acquired.

In addition, in another non-limiting example, a process of editing a blueprint may be allowed in the communication terminal 150 and/or the server 200. As a non-limiting example, when the user of the communication terminal 150 or the administrator of the server 200 desires to edit a blueprint managed in the communication terminal 150 and/or the server 200, an assembled object that appears according to the blueprint may be edited based on an operation performed by the user or administrator, and an edited blueprint for causing the edited object to appear may be newly stored. In that case, in the case in which the position of a material object in the assembled object is desired to be changed or in the case in which a material object is desired to be added, changed, or deleted, the user of the communication terminal 150 or the administrator of the server 200 may perform editing. As another non-limiting example, when a blueprint managed in the communication terminal 150 and/or the server 200 is set as one to be automatically edited in accordance with a predetermined algorithm therein, an assembled object that appears according to the blueprint to be edited may be edited based on the process of the algorithm, and an edited blueprint for causing the edited object to appear may be newly stored. In that case, an edited blueprint for causing a special object limited to a predetermined event or the like to appear may be acquired by the editing. It should be noted that for the edited blueprint, the blueprint ID, thumbnail, and user information (e.g., editor information) may be set and managed like the above blueprint. In addition, when the editing is performed in the communication terminal 150, a blueprint to be edited may be transmitted from the server 200 to the communication terminal 150, in which the edited blueprint is created, and after the editing, the edited blueprint created in the communication terminal 150 may be transmitted to the server 200, in which the edited blueprint may be stored and managed.

In the above other non-limiting example, even when the edited blueprint is newly stored, the blueprint from which the edited blueprint has been created continues to be managed in the original apparatus in which the blueprint has been managed. Data related to the edited blueprint is transmitted and received between the game system 1, the communication terminal 150, and the server 200 like the above blueprint transmission/reception. It should be noted that the edited blueprint and the original blueprint from which the edited blueprint has been created may be managed in association with each other, and the edited blueprint may be restored into the original blueprint from which the edited blueprint has been created, based on a predetermined operation performed by the user or the arrival of a predetermined time, in an apparatus in which the edited blueprint is managed and recorded. In addition, data related to the edited blueprint (e.g., URL information or a thumbnail) may be transmitted from the server 200 to at least one communication terminal 150 (e.g., a communication terminal 150 that manages the original blueprint from which the edited blueprint has been created) with predetermined timing, and may be added to the application-possessed blueprint list of the communication terminal 150. Alternatively, the edited blueprint may be published, with predetermined timing, on a web page, publication, or the like related to the communication system or a game in which the blueprint is used.

Next, a non-limiting example of a specific process executed in the game system 1 will be described with reference to FIGS. 23–27. It should be noted that in the following description of the process, a non-limiting example is used in which a blueprint is recorded in the game system 1 according to the first non-limiting example. FIG. 23 is a diagram showing a non-limiting example of a data area contained in the DRAM 85 of the game system 1. It should be noted that in addition to the data of FIG. 23, the DRAM 85 also stores data that is used in other processes, which will not be described in detail.

Various programs Pa that are executed in the game system 1 are stored in a program storage area of the DRAM 85. In the present non-limiting example, the programs Pa include an application program (e.g., a game program) for performing information processing based on data acquired from the left controller 3 and/or the right controller 4, and the main body apparatus 2, an application program for executing a communication process between the server 200 and the communication terminal 150, and the like. It should be noted that the programs Pa may be previously stored in the flash memory 84, may be acquired from a storage medium removably attached to the game system 1 (e.g., a predetermined type of storage medium attached to the slot 23) and then stored in the DRAM 85, or may be acquired from another apparatus via a network, such as the Internet, and then stored in the DRAM 85. The processor 81 executes the programs Pa stored in the DRAM 85.

Various kinds of data that are used in processes such as an information process that are executed in the game system 1 are stored in a data storage area of the DRAM 85. In the present non-limiting example, the DRAM 85 stores operation data Da, the record data Db, model data Dc, coverage area data Dd, player character data De, object data Df, recording process flag data Dg, appearance process flag data Dh, transmission/reception data Di, image data Dj, and the like.

The operation data Da is acquired, as appropriate, from each of the left controller 3 and/or the right controller 4 and the main body apparatus 2. As described above, the operation data acquired from each of the left controller 3 and/or the right controller 4 and the main body apparatus 2 includes information about an input from each input section (specifically, each button, an analog stick, a touch panel, or each sensor) (specifically, information about an operation, and the result of detection by each sensor). In the present non-limiting example, operation data is acquired from each of the left controller 3 and/or the right controller 4 and the main body apparatus 2 through wireless communication. The acquired operation data is used to update the operation data Da as appropriate. It should be noted that the operation data Da may be updated for each frame that is the cycle of a process executed in the game system 1, or may be updated each time operation data is acquired.

The record data Db indicates design information about each recorded assembled object. For example, for each recorded assembled object, the record data Db includes data indicating design information including a blueprint in which the types of material objects constituting the recorded assembled object, the positions at which the material objects are bonded together, the orientation of each material object, the thumbnail of the assembled object, information about the user that has created the assembled object, and the like.

The model data Dc indicates the type, position, orientation, display form, and the like of an expected completed model object disposed in the virtual space.

The coverage area data Dd indicates the position, size, shape, and the like of a coverage area disposed in the virtual space.

The player character data De indicates the position and orientation of the player character PC disposed in the virtual space, the movement and state of the player character PC in the virtual space, and the like. The player character data De also includes data indicating the types, number, and the like of stored objects temporarily stored by the player character PC. The object data Df indicates the type, position, orientation, state, bonding to other objects, display form, and the like of each object disposed in the virtual space. It should be noted that the object data Df may contain data related to any object. For example, the object data Df may contain data related to an object that is a base for an assembled object, and in addition, data related to a wearable object that a player character PC can wear, a recovery object that recovers the physical strength value of a player character PC, a material object that may be a material for any object, and the like.

The recording process flag data Dg indicates a recording process flag that is set “on” for the game mode in which an assembled object is recorded. The appearance process flag data Dh indicates an appearance process flag that is set “on” for the game mode in which an assembled object is caused to appear.

The transmission/reception data Di is transmitted and received to and from the server 200. For example, data is transmitted and received in the network communication section 82 via the network 300, and the transmission/reception data Di is updated as appropriate in response to transmission and reception of the data. It should be noted that the transmission/reception data Di may be updated for each frame that is the cycle of a process executed in the game system 1 as described below, or may be updated each time the data is transmitted and received.

The image data Dj is for displaying an image (e.g., an image of a character or object, an image of the virtual space, and a background image) on a display screen (e.g., the display 12 of the game system 1).

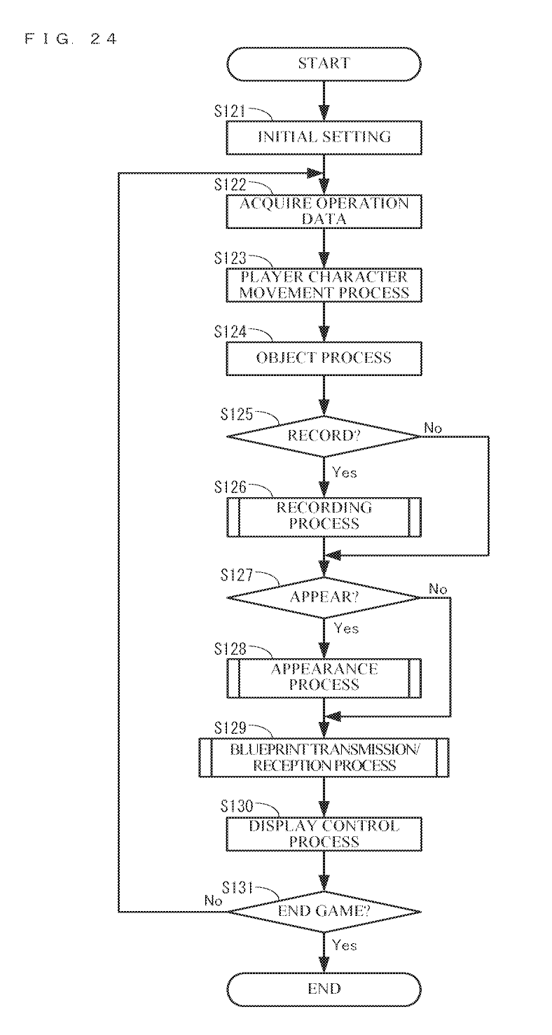

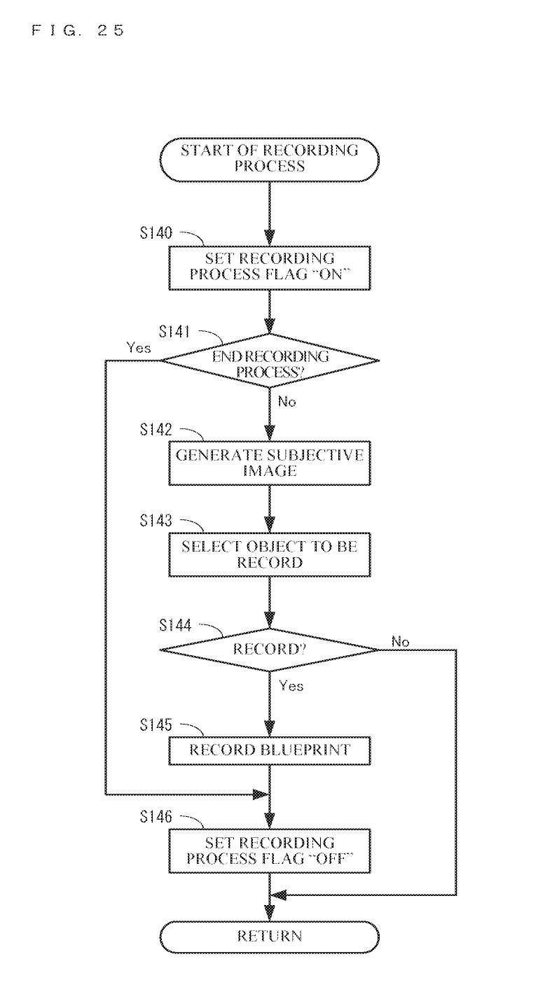

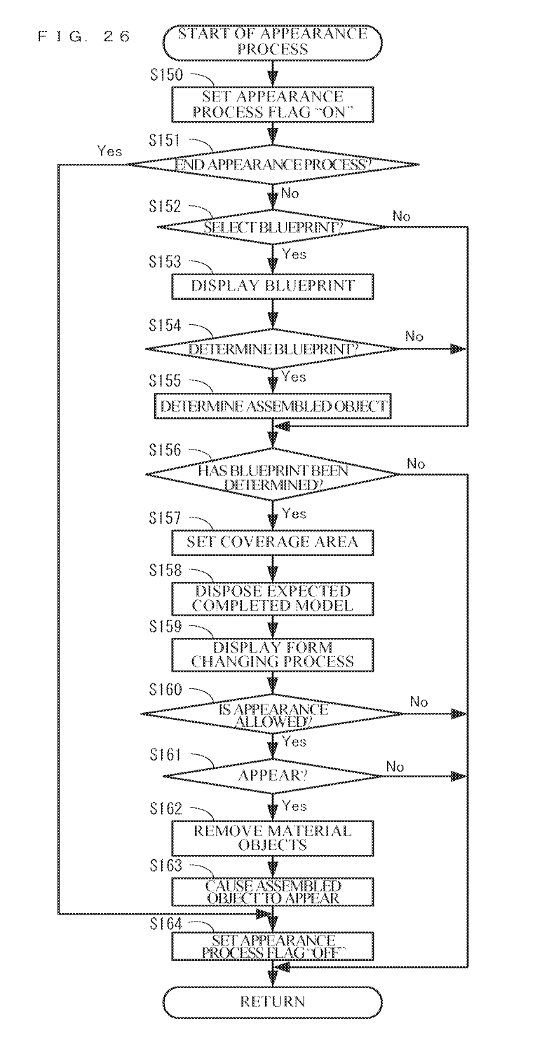

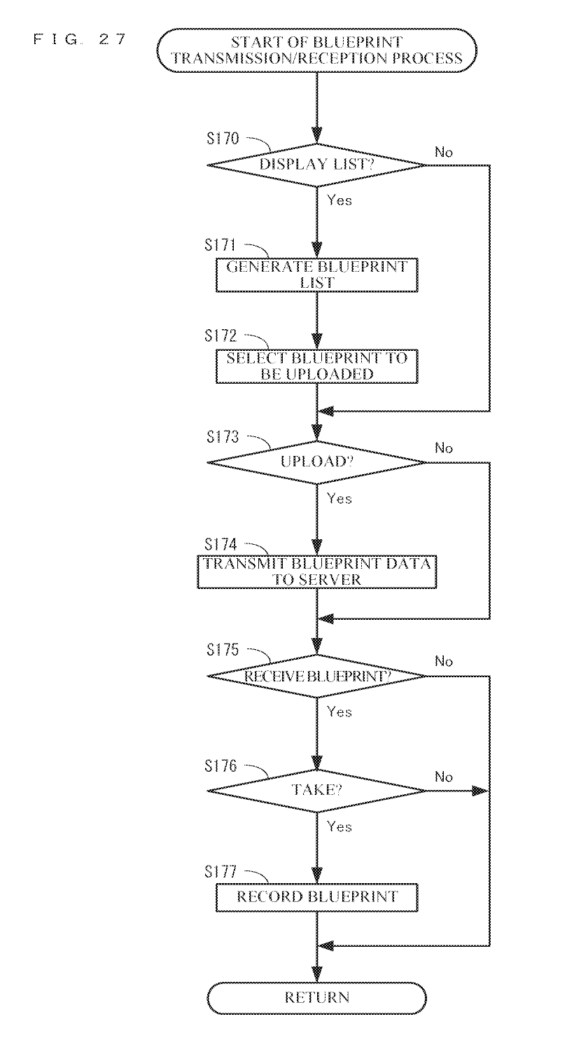

Next, a specific non-limiting example of an information process and a communication process that are performed in the game system 1 of the present non-limiting example will be described with reference to FIGS. 24–27. FIG. 24 is a flowchart showing a non-limiting example of an information process and a communication process that are executed in the game system 1. FIG. 25 is a subroutine showing a specific non-limiting example of a recording process that is executed in step S126 shown in FIG. 24. FIG. 26 is a subroutine showing a specific non-limiting example of an appearance process that is executed in step S128 shown in FIG. 24. FIG. 27 is a subroutine showing a specific non-limiting example of a blueprint transmission/reception process that is executed in step S129 shown in FIG. 24. In the present non-limiting example, a series of processes shown in FIGS. 24–27 is executed by the processor 81 executing a predetermined application program (a game program and communication program) included in the programs Pa. The information and communication processes of FIGS. 24–27 are started with any suitable timing.

It should be noted that the steps in the flowchart of FIGS. 24–27, which are merely illustrative, may be executed in a different order, or another step may be executed in addition to (or instead of) each step, if a similar effect is acquired. In the present non-limiting example, it is assumed that the processor 81 executes each step of the flowchart. Alternatively, a portion of the steps of the flowchart may be executed by a processor or dedicated circuit other than the processor 81. In addition, a portion of the steps executed by the game system 1 may be executed by another information processing apparatus that can communicate with the game system 1 (e.g., another server that can communicate with the server 200 or the game system via a network). Specifically, the steps of FIGS. 24–27 may be executed by a plurality of information processing apparatuses including the game system 1 cooperating with each other. Alternatively, each program used in the present non-limiting example may include instructions that can be executed by a computer.

In FIG. 24, the processor 81 executes initial setting for the information process and communication process (step S121), and proceeds to the next step. For example, in the initial setting, the processor 81 initializes parameters for performing processes described below. For example, the processor 81 initially disposes the player character PC and a plurality of objects in the virtual space based on predetermined settings for the virtual space, and initially sets the player character data De and the object data Df.

Next, the processor 81 obtains operation data from each of the left controller 3, the right controller 4, and/or the main body apparatus 2, and updates the operation data Da (step S122), and proceeds to the next step.

Next, the processor 81 moves the player character PC in the virtual space (step S123), and proceeds to the next step. For example, the processor 81 moves the player character PC based on the operation data Da acquired in step S122, and updates the player character data De.

Next, the processor 81 moves each object in the virtual space (step S124), and proceeds to the next step. For example, the processor 81 moves each object disposed in the virtual space based on the movement of the player character PC (e.g., the player character PC’s motion of moving a vehicle object), the movements of the object itself and other objects, and virtual physical calculation in the virtual space, and updates the object data Df. In addition, the processor 81, when newly disposing an object in the virtual space in response to a game event, adds data related to the object to update the object data Df. In addition, the processor 81, when causing the player character PC to temporarily store an object disposed in the virtual space or a newly acquired object, updates the player character data De using said object as a stored object. Furthermore, when objects are connected together or objects connected together are separated from each other, depending on the player character PC, the processor 81 updates the object data Df, depending on the state of the connection. It should be noted that an object movement circuit is for moving a material object in a virtual space based on the user’s operation, and as a non-limiting example, corresponds to the processor 81 that executes step S124. In addition, an assembled object creation circuit is for creating an assembled object by putting a plurality of material objects together based on the user’s operation, and as a non-limiting example, corresponds to the processor 81 that executes step S124.

Next, the processor 81 determines whether or not to perform the recording process (step125). For example, if the operation data acquired in step S122 indicates the user’s instruction to transition to the game mode in which the recording process is performed or if the recording process flag indicated by the recording process flag data Dg is “on,” the result of the determination in step S125 by the processor 81 is positive. If the processor 81 determines to perform the recording process, the processor 81 proceeds to step S126. Meanwhile, if the processor 81 does not determine to perform the recording process, the processor 81 proceeds to step S127.

In step S126, the processor 81 executes the recording process, and proceeds to step S127. The recording process executed in step S126 will now be described with reference to FIG. 25. It should be noted that a product setting circuit is for executing a process of setting an assembled object created by putting a plurality of material objects together, as a product that can be caused to appear, and as a non-limiting example, corresponds to the processor 81 that executes step S126.

In FIG. 25, the processor 81 sets the recording process flag “on” (step S140), and proceeds to the next step. For example, the processor 81 sets the recording process flag “on,” and updates the recording process flag data Dg.

Next, the processor 81 determines whether or not to end the game mode in which the recording process is performed (step S141). The condition for ending the game mode in which the recording process is performed, in step S141, is, for example, that the condition for ending the game mode is satisfied, that the user performs an operation for ending (canceling) the game mode, that the user performs an operation of determining not to record an assembled object to be recorded, as a blueprint, etc. If the processor 81 does not determine to end the game mode in which the recording process is performed, the processor 81 proceeds to step S142. If the processor 81 determines to end the game mode in which the recording process is performed, the processor 81 proceeds to step S146.

Next, the processor 81 generates a subjective image of the virtual space as viewed from the player character PC (step S142), and proceeds to the next step. For example, the processor 81 disposes a virtual camera whose position and orientation are set such that the focal point of the virtual camera is located in front of the player character PC relative to the gaze point of the player character PC, and generates a subjective image for the player character PC.

Next, the processor 81 selects an assembled object to be recorded, using the subjective image generated in step S142 (step S143), and proceeds to the next step. For example, the processor 81 selects an assembled object to be recorded as a blueprint from objects in the virtual space included in the subjective image according to a predetermined selection rule. As a non-limiting example, if there are a plurality of assembled objects included in the subjective image, the processor 81 selects an assembled object closest to the gaze point in the subjective image as an object to be recorded.

Next, the processor 81 determines whether or not to record the assembled object that is currently to be record as a blueprint (step S144). For example, if the operation data acquired in step S122 indicates an instruction to record the assembled object, the result of the determination in step S144 by the processor 81 is positive. If the processor 81 determines to record the assembled object that is currently to be record as a blueprint, the processor 81 proceeds to step S145. Meanwhile, if the processor 81 does not determine to record the assembled object that is currently to be record as a blueprint, the processor 81 ends the subroutine.

Next, the processor 81 records design information about the assembled object to be recorded (step S145), and proceeds to step S146. For example, the processor 81 adds, to the record data Db, design information indicating the configuration of the assembled object to be recorded that has been selected in step S144. As a non-limiting example, design information recorded in the record data Db contains a blueprint for creating an assembled object to be recorded, a thumbnail of the assembled object, information about the user that has created the assembled object (e.g., a user ID and a user name), and the like. Here, the thumbnail is created using a subjective image generated in step S142. The thumbnail may be an image that is created by any suitable method. For example, the thumbnail may be an image acquired by reducing the subjective image, an image acquired by reducing an image of an assembled object to be recorded that is cut out from the subjective image, or an image acquired by reducing an image of an assembled object captured in a predetermined direction, instead of the subjective image.

In step S146, the processor 81 sets the recording process flag “off,” and ends the subroutine. For example, the processor 81 sets the recording process flag “off,” and updates the recording process flag data Dg.

Referring back to FIG. 24, in step S127, the processor 81 determines whether or not to perform the appearance process. For example, if the operation data acquired in step S122 indicates the user’s instruction to transition to the game mode in which the appearance process is performed, or if the appearance process flag indicated by the appearance process flag data Dh is “on,” the result of the determination in step S127 by the processor 81 is positive. If the processor 81 determines to perform the appearance process, the processor 81 proceeds to step S128. Meanwhile, if the processor 81 does not determine to perform the appearance process, the processor 81 proceeds to step S129.

In step S128, the processor 81 executes the appearance process, and proceeds to step S129. The appearance process executed in step S128 will now be described with reference to FIG. 26.

In FIG. 26, the processor 81 sets the appearance process flag “on” (step S150), and proceeds to the next step. For example, the processor 81 sets the appearance process flag “on,” and updates the appearance process flag data Dh.

Next, the processor 81 determines whether or not to end the game mode in which the appearance process is performed (step S151). The condition for ending the game mode in which the appearance process is performed, in step S151, is, for example, that the condition for ending the game mode is satisfied, that the user performs an operation for ending (canceling) the game mode, etc. If the processor 81 does not determine to end the game mode in which the appearance process is performed, the processor 81 proceeds to step S152. If the processor 81 determines to end the game mode in which the appearance process is performed, the processor 81 proceeds to step S164.

Next, the processor 81 determines whether or not the current stage is one on which the user should be prompted to select a blueprint (step S152). As a non-limiting example, if the current stage is one on which a blueprint has already been determined, the result of the determination in step S152 by the processor 81 is negative. If the current state is one on which the user should be prompted to select a blueprint, the processor 81 proceeds to step S153. Meanwhile, if the current state is not one on which the user should be prompted to select a blueprint, the processor 81 proceeds to step S156.

In step S153, the processor 81 sets a game image that shows blueprints selectable by the user and prompts the user to select one from the selectable blueprints, and proceeds to the next step. For example, the processor 81 extracts design information about all assembled objects recorded in the record data Db, generates a game image showing a list of blueprints of assembled objects produced based on the design information, and prompts the user to select one from the blueprints. At this time, an expected completed model (expected completed model object) based on the blueprint temporarily selected by the user and a coverage area may be displayed in the virtual space, depending on the current position and orientation of the player character PC. In addition, images of stored objects of the player character PC that can be used in the assembled object indicated by the blueprint temporarily selected by the user may be displayed around said blueprint. In addition, information about the user that has created a temporarily selected blueprint may be displayed around the blueprint.

Next, the processor 81 determines whether or not the user’s operation of determining a blueprint has been performed (step S154). For example, if the operation data acquired in step S122 indicates the user’s instruction to determine a blueprint, the result of the determination in step S154 by the processor 81 is positive. If the user’s operation of determining a blueprint has been performed, the processor 81 proceeds to step S155. Meanwhile, if the user’s operation of determining a blueprint has not been performed, the processor 81 proceeds to step S156.

In step S155, the processor 81 determines an assembled object to be caused to appear, and proceeds to step S156. For example, the processor 81 determines the assembled object produced based on the currently selected blueprint as an assembled object to be caused to appear, and extracts design information about said assembled object from the record data Db. Thereafter, the processor 81 sets data for displaying an expected completed model object based on the design information, and updates the model data Dc using said data.

In step S156, the processor 81 determines whether or not a blueprint has been determined. If a blueprint has been determined, the processor 81 proceeds to step S157. Meanwhile, if a blueprint has not been determined, the processor 81 ends the subroutine. It should be noted that even after a blueprint has once been determined, selection of a blueprint may be performed again. In that case, if the result of the determination in step S152 by the processor 81 is positive, selection of a blueprint can be performed again.

In step S157, the processor 81 sets a coverage area in the virtual space, and proceeds to the next step. For example, the processor 81 sets a coverage area around a position on the ground that is located at a predetermined distance in front of the player character PC (see FIG. 12), and updates the coverage area data Dd based on the coverage area. It should be noted that a region setting circuit is for executing a process of setting a region at a predetermined position in a virtual space based on the user’s operation, and as a non-limiting example, corresponds to the processor 81 that executes step S157.

Next, the processor 81 disposes the expected completed model object in the virtual space (step S158), and proceeds to the next step. For example, the processor 81 disposes the expected completed model object indicated by the model data Dc in the virtual space at the center of the coverage area set in step S157.

Next, the processor 81 executes the process of changing the display forms of material objects disposed in the virtual space and the expected completed model object (step S159), and proceeds to the next step. For example, the processor 81 changes the display form of the material objects disposed in the coverage area set in step S157 that will be actually used when an assembled object set as one to be caused to appear appears, from the default display form, and updates the object data Df using the changed display form. In addition, when the coverage area moves, then if a material object leaves the coverage area, the processor 81 returns the display form of the material object to the default display form, and updates the object data Df using the changed display form. In addition, the processor 81 extracts the stored objects of the player character PC that will be actually used when an assembled object set as one to be caused to appear appears, and provides settings for displaying an image indicating the extracted objects in a game image (e.g., around the selected blueprint). In addition, if a material object required for completion of an assembled object corresponding to the expected completed model object currently set is present in the coverage area and/or is among the stored objects, the processor 81 changes the display form of the corresponding material object portion from the default display form, and updates the model data Dc using the changed display form. If a material object required for completion of the assembled object leaves the coverage area and there are not enough material objects, the processor 81 returns the display form of the corresponding material object portion to the default display form, and updates the model data Dc using the changed display form. It should be noted that if there is another object that would penetrate into the expected completed model object, and therefore, there is not a space for disposing the expected completed model object in the coverage area, the processor 81 may not display or may gray out the expected completed model object.

Next, the processor 81 determines whether or not the assembled object that is currently to be caused to appear can be caused to appear (step S160). For example, if every one of the material objects required for completion of the assembled object to be caused to appear is present in the coverage area and/or is among the stored objects, the processor 81 determines that the assembled object can be caused to appear. If the assembled object can be caused to appear, the processor 81 proceeds to step S161. Meanwhile, if the assembled object cannot be caused to appear, the processor 81 ends the subroutine. It should be noted that if there is another object that would penetrate into the expected completed model object, and therefore, there is not a space for disposing the expected completed model object in the coverage area, the processor 81 may determine that the assembled object cannot be caused to appear.

In step S161, the processor 81 determines whether or not to cause the assembled object to be caused to appear to appear in the virtual space. For example, if the operation data acquired in step S122 indicates the user’s instruction to cause the assembled object to be caused to appear to appear in the virtual space, the result of the determination in step S161 by the processor 81 is positive. If the assembled object to be caused to appear is caused to appear in the virtual space, the processor 81 proceeds to step S162. Meanwhile, if the assembled object to be caused to appear is not caused to appear in the virtual space, the processor 81 ends the subroutine.

In step S162, the processor 81 removes the material objects used in the appearing assembled object from the virtual space, and proceeds to the next step. For example, the processor 81 deletes, from the object data Df, the data related to the material objects disposed in the virtual space that are used in the appearing assembled object. In addition, the processor 81 deletes, from the player character data De, the data related to the material objects selected from the stored objects that are used in the appearing assembled object.

Next, the processor 81 causes the assembled object to be caused to appear to appear (step S163), and proceeds to step S164. For example, the processor 81 causes the expected completed model object indicated by the model data Dc to transition to an assembled object whose display form has been changed to the normal display form (e.g., the translucent display form is changed to the same display form as that of the virtual object disposed in the virtual space), and adds data related to said assembled object to the object data Df so that said assembled object is present in the virtual space. It should be noted that a product appearance circuit is for causing a product corresponding to a plurality of material objects using at least a material object(s) at least a portion of which is included in a region such that at least a portion of the product is included in the region, and as a non-limiting example, corresponds to the processor 81 that executes step S163.

It should be noted that in steps S162 and S163, data related to material objects used in an assembled object are deleted from the object data Df, and data related to the assembled object is added to the object data Df. As described above, the process of deleting material objects may be carried out using any of the following processes.

(a) Temporarily deleting data of material objects that are incorporated into an assembled object from the object data Df, and adding data of a newly assembled object including said material objects to the object data Df

(b) Changing at least a portion (position data, orientation data, bonding information, etc.) of the data of material objects that should be incorporated into an assembled object to those of the material objects that have been incorporated into the assembled object, and leaving the data of the material objects as data of the assembled object in the object data Df

In the process (b), data of a material object in the object data Df can be stored as a portion of the data of an assembled object including the material object in the object data Df. As used herein, the meaning of the term “delete” with respect to data of a material object does not exclude the situation that after the data of the material object is deleted, the data of the material object is used as a portion of the data of another object (specifically, an assembled object).

In step S164, the processor 81 sets the appearance process flag “off,” and ends the subroutine. For example, the processor 81 sets the appearance process flag “off,” and updates the appearance process flag data Dh.

Referring back to FIG. 24, in step S129, the processor 81 executes a blueprint transmission/reception process, and proceeds to step S130. The blueprint transmission/reception process of step S129 will be described.

In FIG. 27, the processor 81 determines whether or not to display a blueprint list (step S170). For example, if the operation data acquired in step S122 indicates the user’s instruction to display a blueprint list or the processor 81 is executing a process of displaying a blueprint list, the result of determination by the processor 81 in step S170 is positive. If the processor 81 determines to display a blueprint list, the processor 81 proceeds to step S171. Otherwise, i.e., if the processor 81 does not determine to display a blueprint list, the processor 81 proceeds to step S173.

In step S171, the processor 81 generates a blueprint list, and proceeds to the next step. For example, the processor 81 generates a blueprint list that is a list of blueprints currently possessed by the game system 1 based on the record data Db (see FIGS. 19–22), and displays the blueprint list on the display 12 in a display control process of step S130 described below. It should be noted that the process of generating a blueprint list in step S172 is executed in accordance with the method described above with reference to FIGS. 17–22.

Next, the processor 81 selects a blueprint to be uploaded from the blueprint list (step S172), and proceeds to step S173. For example, the processor 81 selects a blueprint to be uploaded that may be uploaded in step S174 described below from the blueprint list generated in step S171, generates an image showing that the blueprint has been selected as one to be uploaded (e.g., an image showing a blueprint to be processed in FIGS. 19 and 20), and displays the image on the display 12 in a display control process of step S130 described below. It should be noted that the blueprint to be uploaded may be changed based on the operation data acquired in step S122.

In step S173, the processor 81 determines whether or not to upload the blueprint. For example, if the operation data acquired in step S122 indicates the user’s instruction to upload the blueprint (e.g., the user’s instruction to “transmit to the application” by operating the X-button (operation button 55) shown in FIGS. 19 and 20), the result of determination by the processor 81 in step S173 is positive. If the processor 81 determines to upload the blueprint, the processor 81 proceeds to step S174. Otherwise, i.e., if the processor 81 does not determine to upload the blueprint, the processor 81 proceeds to step S175.

In step S174, the processor 81 transmits, to the server 200, data related to the blueprint for which the upload instruction has been provided. For example, the processor 81 puts transmission data such as the data, thumbnail, and user information of the blueprint for which the upload instruction has been provided, into the transmission/reception data Di, by referring to the record data Db, and transmits the transmission data to the server 200 by a process executed in the network communication section 82.

In step S175, the processor 81 determines whether or not a blueprint has been received from the server 200. For example, if data of a blueprint transmitted from the server 200 and received by a process executed in the network communication section 82 (e.g., a set of a blueprint, a thumbnail, and user information) is contained in the transmission/reception data Di, the result of determination by the processor 81 in step S175 is positive. If a blueprint has been received from the server 200, the processor 81 proceeds to step S175. Otherwise, i.e., if a blueprint has not been received from the server 200, the processor 81 ends the subroutine.

In step S176, the processor 81 determines whether or not an operation for taking the blueprint received in step S175 has been performed. For example, if the operation data acquired in step S122 indicates the user’s instruction to take the blueprint (e.g., the user’s instruction to “take” by operating the “+” button (operation button 57) shown in FIGS. 19 and 20), the result of determination by the processor 81 in step S176 is positive. If the operation for taking the blueprint has been performed, the processor 81 proceeds to step S177. Otherwise, i.e., if the operation for taking the blueprint has not been performed, the processor 81 ends the subroutine.

In step S177, the processor 81 records the blueprint received in step S175, and ends the subroutine. For example, the processor 81 adds a new blueprint to the record data Db using data of the blueprint received in step S175 (a set of a blueprint, a thumbnail, and user information).

Referring back to FIG. 24, in step S130, the processor 81 executes a display control process, and proceeds to the next step. For example, the processor 81 disposes the player character PC, virtual objects including material objects, assembled objects, and the like, an expected completed model object, a coverage area, and the like, in the virtual space, based on the record data Db, the model data Dc, the coverage area data Dd, the player character data De, the object data Df, the image data Dj, and the like. The processor 81 also sets the position and/or orientation of a virtual camera for generating a display image based on the operation data Da, and the position and orientation, etc., of the player character PC, and disposes the virtual camera in the virtual space. Thereafter, the processor 81 generates an image of the virtual space as viewed from the set virtual camera, and displays the virtual space image on the display 12. In addition, if the processor 81 determines to display a blueprint list, the processor 81 performs control to display the blueprint list generated in step S172 on the display 12.

Next, the processor 81 determines whether or not to end the game process (step S131). The condition for ending the game process in step S131 is, for example, that the condition for ending the game process is satisfied, that the user performs an operation for ending the game process, etc. If the processor 81 does not determine to end the game process, the processor 81 returns to step S122 and repeats the process. If the processor 81 determines to end the game process, the processor 81 ends the process of the flowchart. Thereafter, the processor 81 repeatedly executes the series of steps S122–S131 until the processor 81 determines to end the process in step S131.

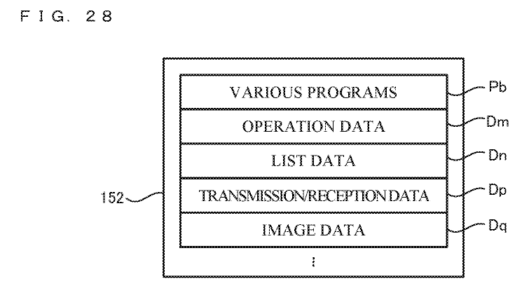

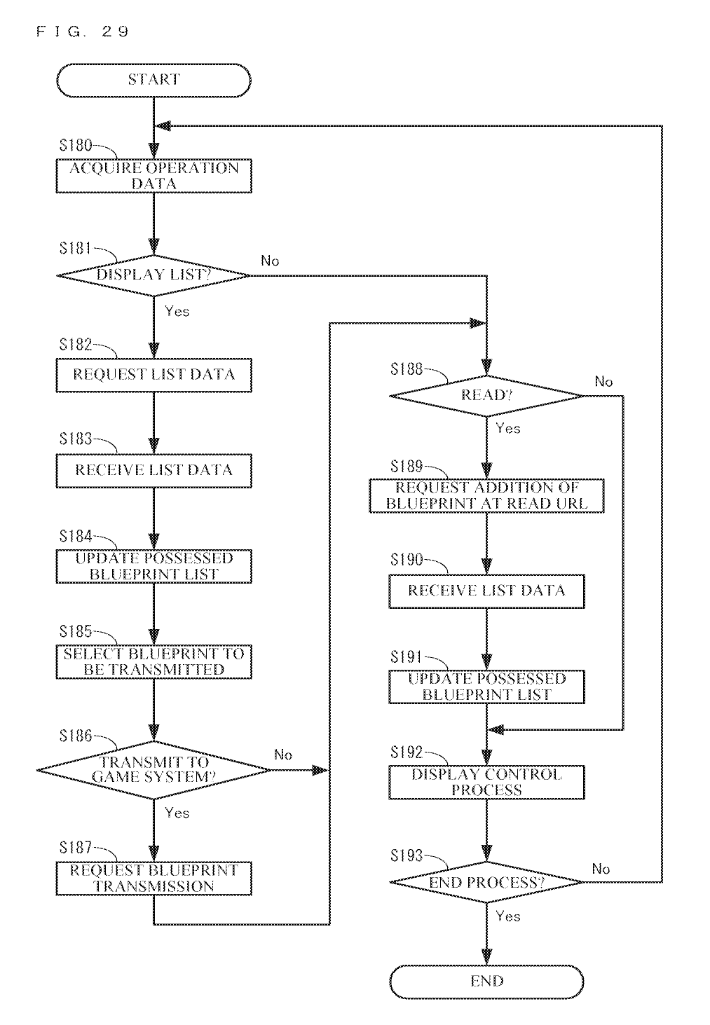

Next, a non-limiting example of a specific process executed in the communication terminal 150 will be described with reference to FIGS. 28 and 29. FIG. 28 is a diagram showing a non-limiting example of a data area set in the storage section 152 of the communication terminal 150. It should be noted that in addition to the data shown in FIG. 28, the storage section 152 also stores data used in other processes, which will not be described in detail.

A program storage area of the storage section 152 stores various programs Pb that are executed in the communication terminal 150. In the present non-limiting example, the programs Pb include an application program for executing an information process based on data acquired from the input section 154, an application program for executing a communication process between the server 200 and the communication terminal 150, and the like. It should be noted that the programs Pb may be previously stored in the program storage section 153, may be acquired from a storage medium removably attached to the communication terminal 150 and then stored in the storage section 152, or may be acquired from other apparatuses via a network such as the Internet and then stored in the storage section 152. The control section 151 executes the programs Pb stored in the storage section 152.

In addition, various kinds of data that are used in an information process executed in the communication terminal 150 are stored in a data storage area of the storage section 152. In the present non-limiting example, the storage section 152 stores operation data Dm, list data Dn, transmission/reception data Do, image data Dq, and the like.

The operation data Dm is acquired as appropriate from the input section 154, and is updated as appropriate using operation data acquired from the input section 154. It should be noted that the operation data Dm may be updated for each frame that is the cycle of a process executed in the game system 1 as described below, or may be updated each time the operation data is obtained.

The list data Dn indicates information about a blueprint possessed in an application that is executed in the communication terminal 150. For example, the list data Dn contains information about each possessed blueprint such as a blueprint ID, a thumbnail, and information about the user that has created the blueprint.

The transmission/reception data Do is transmitted and received to and from the server 200. For example, data is transmitted and received in the communication section 156 via the network 300, and the transmission/reception data Do is updated as appropriate in response to transmission/reception of the data. It should be noted that the transmission/reception data Do may be updated for each frame that is the cycle of the process executed in the communication terminal 150 as described below, or may be updated each time the data is transmitted and received.

The image data Dq is for displaying, on the display section 155, an image (e.g., an image of the application-possessed blueprint list, images of various operation buttons, and a background image).

Next, a specific non-limiting example of an information process and a communication process that are executed in the communication terminal 150 in the present non-limiting example will be described with reference to FIG. 29. FIG. 29 is a flowchart showing a non-limiting example of an information process and a communication process that are executed in the communication terminal 150. In the present non-limiting example, a series of processes shown in FIG. 29 is executed by the control section 151 executing a predetermined application program (an information process program and a communication program) included in the programs Pb. In addition, the timing with which the information process and communication process shown in FIG. 29 are started is not particularly limited.

It should be noted that the steps in the flowchart of FIG. 29, which are merely illustrative, may be executed in a different order, or another step may be executed in addition to (or instead of) each step, if a similar effect is acquired. In the present non-limiting example, it is assumed that the control section 151 executes each step of the flowchart. Alternatively, a portion of the steps of the flowchart may be executed by a processor or dedicated circuit other than the control section 151. In addition, a portion of the steps executed by the communication terminal 150 may be executed by another information processing apparatus that can communicate with the communication terminal 150 (e.g., another server that can communicate with the server 200 or the communication terminal 150 via a network). Specifically, the steps of FIG. 29 may be executed by a plurality of information processing apparatuses including the communication terminal 150 cooperating with each other.

In FIG. 29, the control section 151 acquires operation data from the input section 154, updates the operation data Dm (step S180), and proceeds to the next step.

Next, the control section 151 determines whether or not to display the application-possessed blueprint list (step S181). For example, if the operation data acquired in step S180 indicates the user’s instruction to display the application-possessed blueprint list or if the control section 151 is executing a process of displaying the application-possessed blueprint list, the result of determination by the control section 151 in step S181 is positive. If the control section 151 determines to display the application-possessed blueprint list, the control section 151 proceeds to step S182. Otherwise, i.e., if the control section 151 does not determine to display the application-possessed blueprint list, the control section 151 proceeds to step S188.

In step S182, the control section 151 requests the list data from the server 200, and proceeds to the next step. For example, the control section 151 puts data for requesting the document of the application-possessed blueprint list from the server 200 into the transmission/reception data Dp, and transmits the request data to the server 200 by a process executed by the communication section 156.

Next, the control section 151 receives the list data from the server 200 (step S183), and proceeds to the next step. For example, the control section 151 acquires the document of the application-possessed blueprint list contained in the transmission/reception data Dp transmitted from the server 200 and received by a reception process executed by the communication section 156. As a non-limiting example, the document of the application-possessed blueprint list transmitted from the server 200 is data for displaying the blueprint ID, URL information, thumbnail, and user information of each blueprint possessed in an application that is being executed in the communication terminal 150.

Next, the control section 151 updates the application-possessed blueprint list (step S184), and proceeds to the next step. For example, the control section 151 updates the list data Dn using the document of the application-possessed blueprint list received in step S183. Thereafter, the control section 151 generates the application-possessed blueprint list based on the list data Dn (see FIGS. 18 and 20–22), and displays the application-possessed blueprint list on the display section 155 by a display control process of step S192 described below. It should be noted that the process of generating the application-possessed blueprint list in step S184 is executed in accordance with the method described above with reference to FIGS. 17–22.

Next, the control section 151 selects a blueprint to be transmitted from the application-possessed blueprint list (step S185), and proceeds to the next step. For example, the control section 151 selects a blueprint to be transmitted that may be requested for transmission in step S187 described below from the application-possessed blueprint list generated in step S184, generates an image indicating that the transmission has been selected (e.g., a solid-line image surrounding the blueprint information Ly in FIG. 22), and displays the image on the display section 155 by a display control process of step S192 described below. It should be noted that the blueprint to be transmitted may be changed based on the operation data acquired in step S180.

In step S186, the control section 151 determines whether or not to transmit the blueprint to the game system 1. For example, if the operation data acquired in step S181 indicates the user’s instruction to transmit the blueprint to the game system 1 (e.g., the user’s instruction provided by performing a touch operation on the operation button By2 shown in the upper diagram of FIG. 22), the result of determination by the control section 151 in step S186 is positive. If the control section 151 determines to transmit the blueprint to the game system 1, the control section 151 proceeds to step S187. Otherwise, i.e., if the control section 151 does not determine to transmit the blueprint to the game system 1, the control section 151 proceeds to step S188.

In step S187, the control section 151 requests the server 200 to transmit the blueprint to the game system 1, and proceeds to step S188. For example, based on the blueprint ID of the blueprint to be transmitted to the game system 1 (e.g., the blueprint corresponding to the thumbnail to which the operation button By2, on which a touch operation has been performed in step S186, is added), the control section 151 puts, into the transmission/reception data Dp, data for requesting the server 200 to transmit the blueprint corresponding to the blueprint ID to the game system 1, and transmits the request data to the server 200 by a process executed in the communication section 156.

In step S188, the control section 151 determines whether or not to read URL information. For example, if URL information (e.g., a QR code (registered trademark)) is included in a captured image acquired by imaging the real world using the imaging unit 157, the result of determination by the control section 151 in step S188 is positive. If the control section 151 determines to read URL information, the control section 151 proceeds to step S189. Otherwise, i.e., if the control section 151 does not determine to read URL information, the control section 151 proceeds to step S192.

In step S189, the control section 151 transmits, to the server 200, a request for adding a blueprint corresponding to the read URL information, and proceeds to the next step. For example, the control section 151 reads contents included in the image captured by the imaging unit 157 to acquire URL information. Thereafter, based on the acquired URL information, the control section 151 puts, into the transmission/reception data Dp, data for requesting the server 200 to acquire blueprint information corresponding to the URL information, and transmits the request data to the server 200 by a process executed by the communication section 156. It should be noted that as a non-limiting example, step S189 may be executed when the result of determination in step S188 is positive. In addition, as another non-limiting example, step S189 may be executed if, after the result of determination in step S188 is positive, the operation data acquired in step S181 indicates the user’s instruction to add the blueprint corresponding to the URL information (e.g., the user’s instruction provided by performing a touch operation on the operation button By1 shown in the upper diagram of FIG. 21).

Next, the control section 151 receives the list data from the server 200 (step S190), and proceeds to the next step. For example, the control section 151 acquires the document of the application-possessed blueprint list contained in the transmission/reception data Dp transmitted from the server 200 and received by a reception process executed in the communication section 156.

Next, the control section 151 updates the application-possessed blueprint list (step S191), and proceeds to step S192. For example, the control section 151 updates the list data Dn using the document of the application-possessed blueprint list received in step S190. Thereafter, the control section 151 generates the application-possessed blueprint list (see FIGS. 18 and 20–22) based on the list data Dn, and displays the application-possessed blueprint list on the display section 155 by a display control process of step S192 described below.

In step S192, the control section 151 executes a display control process, and proceeds to the next step. For example, the control section 151 performs control to display, on the display section 155, the application-possessed blueprint list generated based on the list data Dn. In addition, if the process of imaging the real world using the imaging unit 157 is being executed, the control section 151 performs control to display the captured mage on the display section 155.

Next, the control section 151 determines whether or not to end the process (e.g., the information process and communication process) (step S193). The condition for ending the process in step S193, is, for example, that the condition for ending the process is satisfied, or that the user performs an operation for ending the process. If the control section 151 does not determine to end the process, the control section 151 returns to and repeats step S180. If the control section 151 determines to end the process, the control section 151 ends the process of the flowchart. Thereafter, the series of processes of steps S181–S193 is repeatedly executed until the control section 151 determines to end the process in step S193.

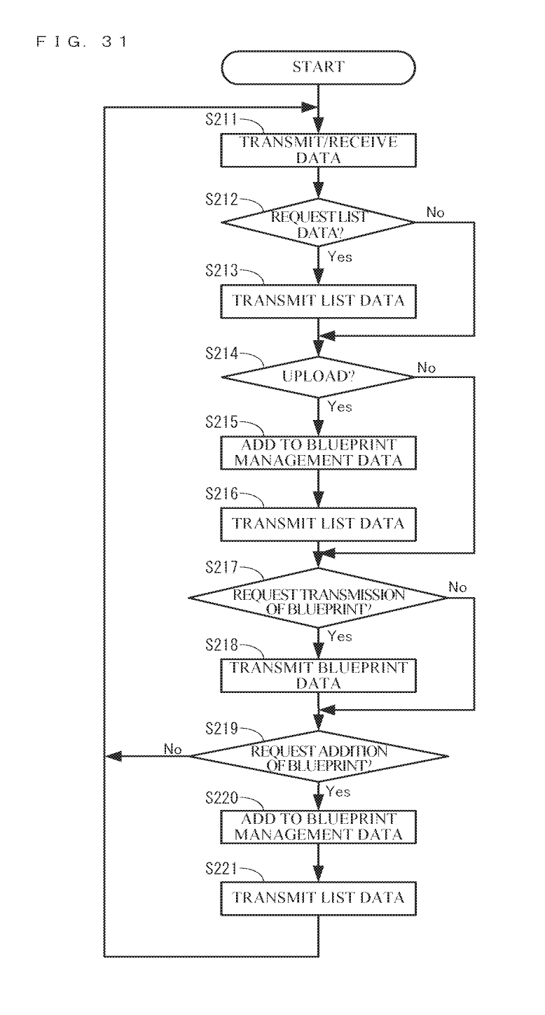

Next, a non-limiting example of a specific process executed in the server 200 will be described with reference to FIGS. 30 and 31. FIG. 30 is a diagram showing a non-limiting example of a data area set in the storage section 203 of the server 200. It should be noted that in addition to the data shown in FIG. 30, the storage section 203 also stores data used in other processes, which will not be described in detail.

A program storage area of the storage section 203 stores various programs Pc that are executed in the server 200. In the present non-limiting example, the programs Pc include an application program for executing a process of managing data stored in the storage section 203, an application program for executing a communication process between the server 200, and the game system 1 and the communication terminal 150, and the like. It should be noted that the programs Pc may be previously stored in the storage section 203, or may be acquired from other apparatuses via a network such as the Internet and then stored in the storage section 203. The control section 202 executes the programs Pc stored in the storage section 203.

In addition, various kinds of data that are used in an information process and the like executed in the server 200 are stored in a data storage area of the storage section 203. In the present non-limiting example, the storage section 203 stores the blueprint management data Dr, transmission/reception data Ds, and the like.

The blueprint management data Dr is related to a blueprint managed in the server 200. For example, the blueprint management data Dr contains data indicating information about each blueprint possessed in each account including the blueprint, the blueprint ID of the blueprint, the thumbnail of the blueprint, information about the user that has created the blueprint, and the like. It should be noted that in the present non-limiting example, a blueprint that has no longer been possessed in an account may continue to be managed in the blueprint management data Dr, and may continue to be stored in the storage section 203. As a result, a blueprint associated with URL information that has once been set continues to be managed without being deleted, and therefore, a user that uses the server 200 can use a blueprint associated with URL information at any time.

The transmission/reception data Ds is transmitted and received between the game system 1 and the communication terminal 150. For example, the communication section 201 transmits and receives data via the network 300, and updates, as appropriate, the transmission/reception data Ds in response to transmission and reception of the data. It should be noted that the transmission/reception data Ds may be updated for each frame that is the cycle of the process executed in the server 200 as described below, or may be updated each time the data is transmitted and received.

Next, a specific non-limiting example of an information process and a communication process that are executed in the server 200 in the present non-limiting example will be described with reference to FIG. 31. FIG. 31 is a flowchart showing a non-limiting example of an information process and a communication process that are executed in the server 200. In the present non-limiting example, a series of processes shown in FIG. 31 is executed by the control section 202 executing a predetermined application program (an information process program and a communication program) included in the programs Pc. In addition, the timing with which the information process and communication process shown in FIG. 31 are started is not particularly limited.

It should be noted that the steps in the flowchart of FIG. 31, which are merely illustrative, may be executed in a different order, or another step may be executed in addition to (or instead of) each step, if a similar effect is acquired. In the present non-limiting example, it is assumed that the control section 202 executes each step of the flowchart. Alternatively, a portion of the steps of the flowchart may be executed by a processor or dedicated circuit other than the control section 202. In addition, a portion of the steps executed by the server 200 may be executed by another information processing apparatus that can communicate with the server 200 (e.g., another server that can communicate with the server 200 via a network). Specifically, the steps of FIG. 31 may be executed by a plurality of information processing apparatuses including the server 200 cooperating with each other.

In FIG. 31, the control section 202 receives data from another apparatus (e.g., the game system 1 and the communication terminal 150) via the network 300, transmits the data to the other apparatus (step S211), and proceeds to the next step. For example, the control section 202 controls the communication section 201 to transmit data contained in the transmission/reception data Ds to a transmission destination apparatus. In addition, the control section 202 controls the communication section 201 to put data received from another apparatus into the transmission/reception data Ds.

Next, the control section 202 determines whether or not a request for the list data has been received from the communication terminal 150 (step S212). For example, if in step S211, data requesting the list data has been received from the communication terminal 150, the result of determination by the control section 202 in step S212 is positive. If a request for the list data has been received from the communication terminal 150, the control section 202 proceeds to step S213. Otherwise, i.e., if a request for the list data has not been received from the communication terminal 150, the control section 202 proceeds to step S214.

In step S213, the control section 202 transmits the list data to the apparatus that has transmitted the request, and proceeds to step S214. For example, the control section 202 refers to the blueprint management data Dr to extract blueprint information (e.g., a blueprint ID, URL information, a thumbnail, and user information of a creator) of the account of the apparatus that has transmitted the request, and creates the extracted blueprint information as the document of an application-possessed blueprint list (the list data). Thereafter, the control section 202 puts the created document of the application-possessed blueprint list into the transmission/reception data Ds, and transmits the transmission/reception data Ds to the apparatus that has transmitted the request, by the process of step S211.

In step S214, the control section 202 determines whether or not uploading of a blueprint has been received from the game system 1. For example, if in step S211, data for uploading a blueprint has been received from the game system 1, the result of determination by the control section 202 in step S214 is positive. Thereafter, if uploading of a blueprint has been received from the game system 1, the control section 202 proceeds to step S215. Otherwise, i.e., if uploading of a blueprint has not been received from the game system 1, the control section 202 proceeds to step S217.

In step S215, the control section 202 adds the blueprint uploaded from the game system 1 to the blueprint management data Dr, and proceeds to the next step. For example, the control section 202 sets a unique blueprint ID for the blueprint uploaded from the game system 1. In addition, the control section 202 sets a URL indicating a place where the blueprint uploaded from the game system 1 is stored and managed in the storage section 203, and sets URL information indicating the URL. Thereafter, the control section 202 adds a set of the blueprint uploaded from the game system 1, the blueprint ID, the URL information, and the uploaded thumbnail and user information, to the blueprint management data Dr, in association with the account of the sender uploading the blueprint.

Next, the control section 202 transmits the list data to the communication terminal 150 having the account to which the blueprint has been added in step S215 (step S216), and proceeds to step S217. For example, the control section 202 refers to the blueprint management data Dr to extract blueprint information corresponding to the account, and creates the extracted blueprint information as the document of an application-possessed blueprint list (list data). Thereafter, the control section 202 puts the created document of the application-possessed blueprint list into the transmission/reception data Ds, and transmits the transmission/reception data Ds to the communication terminal 150 having the account by the process of step S211.

In step S217, the control section 202 determines whether or not a blueprint transmission request has been received from the communication terminal 150. For example, if in step S211, data indicating the blueprint ID of a blueprint requested for transmission has been received from the communication terminal 150, the result of determination by the control section 202 in step S217 is positive. If a blueprint transmission request has been received from the communication terminal 150, the control section 202 proceeds to step S218. Otherwise, i.e., if a blueprint transmission request has not been received from the communication terminal 150, the control section 202 proceeds to step S219.

In step S218, the control section 202 transmits the blueprint requested for transmission to the game system 1 having the account of the sender of the request, and proceeds to step S219. For example, the control section 202 refers to the blueprint management data Dr to extract information about the blueprint corresponding to the blueprint ID requested for transmission (e.g., a set of the blueprint corresponding to the blueprint ID requested for transmission, the thumbnail of the blueprint, and user information), puts the extracted information about the blueprint into the transmission/reception data Ds, and transmits the transmission/reception data Ds to the game system 1 having the account by the process of step S211.

In step S219, the control section 202 determines whether or not a blueprint addition request has been received from the communication terminal 150. For example, if in step S211, data for requesting blueprint information corresponding to URL information has been received from the communication terminal 150, the result of determination by the control section 202 in step S219 is positive. If a blueprint addition request has been received from the communication terminal 150, the control section 202 proceeds to step S220. Otherwise, i.e., if a blueprint addition request has not been received from the communication terminal 150, the control section 202 returns to and repeats step S211.

In step S220, the control section 202 adds a blueprint corresponding to the URL information requested for addition, as a blueprint corresponding to the account of the communication terminal 150 requesting for addition, to the blueprint management data Dr, and proceeds to the next step. For example, the control section 202 refers to the blueprint management data Dr to extract blueprint information corresponding to URL information requested for addition (a blueprint, a blueprint ID, a thumbnail, user information, and the like). Thereafter, the control section 202 adds the extracted blueprint information, as a blueprint corresponding to the account of the communication terminal 150 requesting addition, to the blueprint management data Dr.

Next, the control section 202 transmits the list data to the communication terminal 150 having the account that has sent the blueprint addition request in step S219 (step S221), and returns to and repeats step S211. For example, the control section 202 refers to the blueprint management data Dr to extract blueprint information corresponding to the account, and creates the extracted blueprint information as the document of an application-possessed blueprint list (list data). Thereafter, the control section 202 puts the created document of the application-possessed blueprint list into the transmission/reception data Ds, and transmits the transmission/reception data Ds to the communication terminal 150 having the account by the process of step S211.

Thus, in the above non-limiting example, by reading an image (e.g., a two-dimensional barcode) indicating URL information associated with a blueprint ID in the communication terminal 150, a blueprint used for generating an assembled object can be acquired in the game system 1. In addition, by reading the image, a blueprint ID with which the blueprint can be acquired can be acquired, and therefore, the blueprint can be easily shared with another user using the image.

It should be noted that in the above non-limiting example, a blueprint for causing an assembled object generated by the user to appear in a virtual space again is used, the assembled object that is caused to appear using a blueprint may be a product that has never been generated by the user. For example, a blueprint for causing an assembled object previously prepared by a designer or the like to appear according to the user’s operation may be used. In that case, a blueprint previously prepared by a designer or the like may be acquired as an item that can be acquired by a player character PC during progression of a game.

The term “appear” in the above non-limiting example may not necessarily mean that an assembled object stays at the position where the assembled object appears. Alternatively, after an assembled object appears, a process of positioning the assembled object from the position where the assembled object appears may be performed. For example, an assembled object may be caused to appear at the position in the virtual space where an expected completed model object has been displayed, and thereafter, the position where the assembled object is disposed in the virtual space may be adjusted according to the user’s operation, and the assembled object may be disposed at the adjusted position so that the appearance of the assembled object is completed.

An assembled object that can be caused to appear may be produced using at least one material object belonging to one of stored objects temporarily stored by the player character PC, objects that can be stored by the player character PC and are disposed in the virtual space, and non-storable objects that cannot be stored by the player character PC and are disposed in the virtual space. Therefore, in the above non-limiting example, a game in which at least one of the three types of objects does not exist can be implemented. As a non-limiting example, even in a game in which the player character PC cannot temporarily store an object, the above non-limiting example can be implemented by producing an assembled object by putting only non-storable objects disposed in the virtual space together. The stored objects may not be stored by the player character PC, and may be possessed by the user that operates the player character PC.

When an assembled object is caused to appear, a predetermined item (e.g., a special item that provides the right to cause an assembled object to appear) may be required in addition to the above material objects. As a non-limiting example, when an assembled object is caused to appear, at least one of the item disposed in the coverage area A in the virtual space and/or the item possessed by the player character PC may be consumed. As another non-limiting example, when an assembled object is caused to appear, an availability indicator set for the item disposed in the coverage area A in the virtual space and/or the item possessed by the player character PC may be reduced by a predetermined amount.

In the above non-limiting example, an assembled object is produced as a product by putting a plurality of material objects together by bonding the objects with each other. A plurality of material objects may be fixed together with or without another object interposed therebetween. The bonding in the above non-limiting example includes both of the fixation embodiments, and includes an embodiment in which material objects are put and fixed together by suction, electrical attraction, joining, fusion, welding, pressure bonding, screwing, fitting, sticking, or the like. A plurality of material objects may be altered to have other external appearance without substantially maintaining the original external appearance, and may then form a product. For example, a plurality of material objects may be kneaded, combined, fused, or the like into a single object (product).

Although in the above non-limiting example, the region for using material objects from the virtual space and the region in which a position where an assembled object is caused to appear is displayed are indicated by the same coverage area A, or alternatively, may be different regions. As a non-limiting example, the region for using material objects from the virtual space may be larger than the region in which a position where an assembled object is caused to appear is displayed, or these regions may have different shapes. The position where an assembled object is caused to appear may be freely set by the user irrespective of the region for using material objects.

In addition, stored objects that are temporarily stored by a player character PC may not be used for an assembled object that can be caused to appear. Specifically, an assembled object may be produced using only material objects belonging to either storable objects that can be stored by a player character PC and are disposed in the virtual space or non-storable objects that cannot be stored by a player character PC and are disposed in the virtual space. In order to produce an assembled object using stored objects temporarily stored by the player character PC, it is necessary to temporarily dispose the stored objects in the coverage area A of the virtual space. Nevertheless, an assembled object is produced only from material objects that are present in the coverage area A, and therefore, it is easier to recognize what material objects are used for the assembled object.

When there are not enough material objects to constitute an assembled object to be caused to appear, special objects that can be substituted for lacking material objects may be used. For example, when there not enough log objects and stone objects required for constructing an assembled object, two special objects that can alter into a log object and a stone object, respectively (or objects having shapes similar to a log object and a stone object) may be used to cause an assembled object to appear.

The meaning of the orientation of an object in the above non-limiting examples may include a position and direction of the object.

In addition, in the above non-limiting example, a non-limiting example has been described in which a blueprint for causing an assembled object generated by a user to appear is transmitted and received between the game system 1 (the main body apparatus 2), the communication terminal 150, and the server 200. Alternatively, any contents may be transmitted and received in a communication system. For example, in a craft game, data indicating a virtual object or objects generated by a user may be transmitted and received in a communication system. As a non-limiting example, data indicating a room, building, or the like created in a game space by a user may be transmitted and received in a communication system. As another non-limiting example, data indicating at least a portion of a game stage created by a user or a game space in which a user plays or the like may be transmitted and received in a communication system.

The game system 1 may be any suitable apparatus, including a handheld game apparatus, or any suitable handheld electronic apparatus (a personal digital assistant (PDA), smartphone, mobile telephone, personal computer, camera, tablet computer, etc.), etc. In that case, an input apparatus for performing an operation of moving an object may be, instead of the left controller 3 or the right controller 4, another controller, mouse, touchpad, touch panel, trackball, keyboard, directional pad, slidepad, etc.

In the foregoing, all process steps in the above information process and communication process are performed in the communication system 100 including the game system 1 (the main body apparatus 2), the communication terminal 150, and the server 200. Alternatively, at least a portion of the process steps may be performed in another apparatus. For example, when the game system 1 can also communicate with another apparatus (e.g., another server, another image display apparatus, another game apparatus, another mobile terminal, etc.), the process steps may be executed in cooperation with the second apparatus. By thus causing another apparatus to perform a portion of the process steps, a process similar to the above process can be performed. The above information process and communication process may be executed by a single processor or a plurality of cooperating processors included in an information processing system including at least one information processing apparatus. In the above non-limiting example, the information process and communication process can be executed by the processor 81 of the game system 1, the control section 151 of the communication terminal 150, and the control section 202 of the server 200 executing respective predetermined programs. Alternatively, all or a portion of the above process may be performed by a dedicated circuit included in one of the game system 1, the communication terminal 150, and the server 200.

Here, according to the above non-limiting variation, the present non-limiting example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the above steps may be performed by substantially any of the apparatuses, and the present non-limiting example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the above non-limiting example.

The above program may be supplied to the game system 1, the communication terminal 150, and the server 200 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present non-limiting example and common technical knowledge. It should be understood throughout the present specification that expression of a singular form includes the concept of its plurality unless otherwise mentioned. Specifically, articles or adjectives for a singular form (e.g., “a,” “an,” “the,” etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present non-limiting example pertain. If there is any inconsistency or conflict, the present specification (including the definitions) shall prevail.

Thus, the present non-limiting example can be used as a communication system, communication program, computer-implemented method, and the like that allow a user to easily share a product object generated in a game or the like with another user.

What is claimed is:

1. A communication system comprising a first game apparatus and a first communication terminal, wherein the first game apparatus and the first communication terminal are configured to connect to a server,
the first game apparatus is configured to
execute a first game application, and
during execution of the first game application,
cause a product object generated based on a plurality of material objects to appear in a virtual space according to an instruction based on an operation input,
store first information associated with the product object,
cause the product object related to the first information to appear in the virtual space according to an instruction based on an operation input, and
transmit the first information to the server according to an instruction based on an operation input,
the server is configured to
receive the first information from the first game apparatus or another game apparatus,
generate second information related to the received first information and for identifying the product object,
store the first information and the second information associated with the first information, and
transmit the second information to the first communication terminal based on a request from the first communication terminal,
the first communication terminal is configured to
receive the second information from the server,
store the received second information,
acquire, based on a first image associated with the second information, the second information related to the first image from the server, and
transmit, to the server, an instruction to transmit the first information associated with the second information acquired from the server to the first game apparatus,
the server is configured to transmit, to the first game apparatus, the first information stored in the server and associated with the second information transmitted from the first communication terminal, and
the first game apparatus is configured to receive the first information transmitted from the server.

2. The communication system according to claim 1, further comprising a second game apparatus and a second communication terminal, wherein the second game apparatus and the second communication terminal are configured to connect to the server,
the second communication terminal is configured to
acquire, based on the first image, the second information related to the first image from the server, and
transmit, to the server, an instruction to transmit the first information associated with the second information acquired from the server to the second game apparatus, and
the second game apparatus is configured to
acquire, from the server, the first information associated with the second information and designated by the second communication terminal,
execute a second game application, and
during execution of the second game application,
cause a product object generated based on a plurality of material objects to appear in a virtual space according to an instruction based on an operation input, and
cause a product object related to the first information acquired from the server to appear in the virtual space according to an instruction based on an operation input.

3. The communication system according to claim 1, wherein
the first game apparatus is configured to
store at most a first number of pieces of the first information,
newly store the first information associated with the product object in response to generation of the product object based on a plurality of the material objects according to an instruction based on an operation input, and
when the first number is exceeded due to the newly stored first information, automatically delete one of the stored pieces of first information that started to be stored at a relatively early time.

4. The communication system according to claim 3, wherein
the first communication terminal is configured to
store at most a second number of pieces of the second information,
newly store the second information in response to reception of the second information from the server, and
when the second number is exceeded due to the newly stored second information, automatically delete one of the stored pieces of second information that started to be stored at a relatively early time.

5. The communication system according to claim 4, wherein
the second number is more than the first number.

6. The communication system according to claim 3, wherein
the first game apparatus is configured to
designate one of the stored pieces of first information according to an instruction based on an operation input, and
when the first number is exceeded due to the newly stored first information, automatically delete one of the stored pieces of first information without deleting the designated first information.

7. The communication system according to claim 4, wherein
the first communication terminal is configured to
designate one of the stored pieces of second information according to an instruction based on an operation input, and
when the second number is exceeded due to the newly stored second information, automatically delete one of the stored pieces of second information without deleting the designated second information.

8. The communication system according to claim 1, wherein
the server is configured to transmit, to the first communication terminal, a second image related to the second information and the first information and showing the product object, and
the first communication terminal has a display section and is configured to
display the second image received from the server on the display section in association with the first image.

9. One or more non-transitory computer-readable storage media having stored therein a communication program executable by one or more processors included in a first communication terminal in a communication system including a first game apparatus and the first communication terminal, wherein the first game apparatus and the first communication terminal are configured to connect to a server,
the first game apparatus is configured to
execute a first game application, and
during execution of the first game application,
cause a product object generated based on a plurality of material objects to appear in a virtual space according to an instruction based on an operation input,
store first information associated with the product object,
cause the product object related to the first information to appear in the virtual space according to an instruction based on an operation input, and
transmit the first information to the server according to an instruction based on an operation input,
the server is configured to
receive the first information from the first game apparatus or another game apparatus,
generate second information related to the received first information and for identifying the product object,
store the first information and the second information associated with the first information, and
transmit the second information to the first communication terminal based on a request from the first communication terminal,
the communication program causes the one or more processors to perform operations comprising
receiving the second information transmitted from the server,
storing the received second information,
acquiring, based on a first image associated with the second information, the second information related to the first image from the server, and
transmitting, to the server, an instruction to transmit the first information associated with the second information acquired from the server to the first game apparatus, thereby causing the server to transmit, to the first game apparatus, the first information stored in the server and associated with the transmitted second information, and
the first game apparatus is configured to receive the first information related to the first image and transmitted from the server.

10. One or more non-transitory computer-readable storage media having stored therein a communication program executable by one or more processors included in a first game apparatus in a communication system including the first game apparatus and a first communication terminal, wherein the first game apparatus and the first communication terminal are configured to connect to a server,
the communication program causes the one or more processors to perform operations comprising
executing a first game application, and
during execution of the first game application,
causing a product object generated based on a plurality of material objects to appear in a virtual space according to an instruction based on an operation input,
storing first information associated with the product object,
causing the product object related to the first information to appear in the virtual space according to an instruction based on an operation input, and
transmitting the first information to the server according to an instruction based on an operation input,
the server is configured to
receive the first information from the first game apparatus or another game apparatus,
generate second information related to the received first information and for identifying the product object,
store the first information and the second information associated with the first information, and
transmit the second information to the first communication terminal based on a request from the first communication terminal,
the first communication terminal is configured to
receive the second information from the server,
store the received second information,
acquire, based on a first image associated with the second information, the second information related to the first image from the server, and
transmit, to the server, an instruction to transmit the first information associated with the second information acquired from the server to the first game apparatus,
the server is configured to transmit, to the first game apparatus, the first information stored in the server and associated with the second information transmitted from the first communication terminal, and
the operations further comprise receiving the first information related to the first image and transmitted from the server.

11. A computer-implemented method for use in a communication system including a first game apparatus and a first communication terminal, wherein the first game apparatus and the first communication terminal are configured to connect to a server, the method comprising:
causing the first game apparatus to
execute a first game application, and
during execution of the first game application,
cause a product object generated based on a plurality of material objects to appear in a virtual space according to an instruction based on an operation input,
store first information associated with the product object,
cause the product object related to the first information to appear in the virtual space according to an instruction based on an operation input, and
transmit the first information to the server according to an instruction based on an operation input;
causing the server in the communication system to
receive the first information from the first game apparatus or another game apparatus,
generate second information related to the received first information and for identifying the product object,
store the first information and the second information associated with the first information, and
transmit the second information to the first communication terminal based on a request from the first communication terminal;
causing the first communication terminal in the communication system to
receive the second information from the server,
store the received second information,
acquire, based on a first image associated with the second information, the second information related to the first image from the server, and
transmit, to the server, an instruction to transmit the first information associated with the second information acquired from the server to the first game apparatus;
causing the server to transmit, to the first game apparatus, the first information stored in the server and associated with the second information transmitted from the first communication terminal; and
causing the first game apparatus to receive the first information transmitted from the server.
